(19) United States
(12) Patent Application Publication
(10) Pub. No.: US 2018/0196387 A1
(43) Pub. Date: Jul. 12, 2018

(54) CLEANING BLADE, CLEANING DEVICE, IMAGE FORMING APPARATUS, AND PROCESS CARTRIDGE

(71) Applicant: Kazuhiko WATANABE, Tokyo (JP)

(72) Inventor: Kazuhiko WATANABE, Tokyo (JP)

(73) Assignee: Ricoh Company, Ltd., Tokyo (JP)

(21) Appl. No.: 15/861,804

(22) Filed: Jan. 4, 2018

(30) Foreign Application Priority Data
Jan. 12, 2017 (JP) 2017-003633

(51) Int. Cl. G03G 21/00; G03G 15/04; G03G 15/01; G03G 15/02

(52) U.S. Cl. CPC G03G 21/0017; G03G 15/04036; G03G 2215/0404; G03G 15/0225; G03G 15/0131

(57) ABSTRACT

A cleaning blade includes an elastic blade body. The elastic blade body having an edge contacts a surface of a contact object such as a photoconductor. The cleaning blade removes substances on the surface of the contact object that moves in contact with the edge. With respect to an elastic power Y_{OPC} of the contact object, an elastic power E_{BL} of the cleaning blade satisfies a relation:

Y_{OPC}≥0.55×E_{BL}−3.33.

### CROSS-REFERENCE TO RELATED APPLICATION

This patent application is based on and claims priority pursuant to 35 U.S.C. § 119(a) to Japanese Patent Application No. 2017-003633, filed on Jan. 12, 2017, in the Japan Patent Office, the entire disclosure of which is hereby incorporated by reference herein.

### BACKGROUND

### Technical Field

This disclosure generally relates to a cleaning blade, and a cleaning device, a process cartridge, and an image forming apparatus, such as a copier, a printer, a facsimile machine, or a multifunction peripheral having at least two of copying, printing, facsimile transmission, plotting, and scanning capabilities, which include the cleaning blade.

### Related Art

In the field of image forming apparatuses, a cleaning blade made of elastic material to clean a contact object is known. An edge of the cleaning blade removes substances adhering to the surface of the contact object that moves in contact with the edge.

### SUMMARY

According to an embodiment of the present disclosure, an improved cleaning blade includes an elastic blade body. The elastic blade body having an edge contacts a surface of a contact object such as a photoconductor. The cleaning blade removes substances on the surface of the contact object that moves in contact with the edge. With respect to an elastic power Y_{OPC} of the contact object, an elastic power E_{BL} of the cleaning blade satisfying a relation expressed as:

Y_{OPC}≥0.55×E_{BL}−3.33 Formula A.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to an embodiment of the present disclosure;

FIG. 2 is a schematic view of a process cartridge installable in the image forming apparatus illustrated in FIG. 1;

FIG. 3 is a graph of a relation between an elastic power of a cleaning blade and an elastic power of a photoconductor;

FIGS. 4A though 4E are cross-sectional views perpendicular to an edge of the cleaning blade, illustrating the cleaning blades usable in Embodiment 1.

FIG. 5 is a graph of cumulative stress while a Vickers indenter is pushed in, and in removal of a test load;

FIG. 6 is a schematic view illustrating a process cartridge according to an embodiment of the present disclosure;

FIGS. 7A through 7D illustrate a layered structure of a photoconductor according to an embodiment of the present disclosure; and

FIGS. 8A and 8B are illustrations of measurement of circularity of toner particles.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

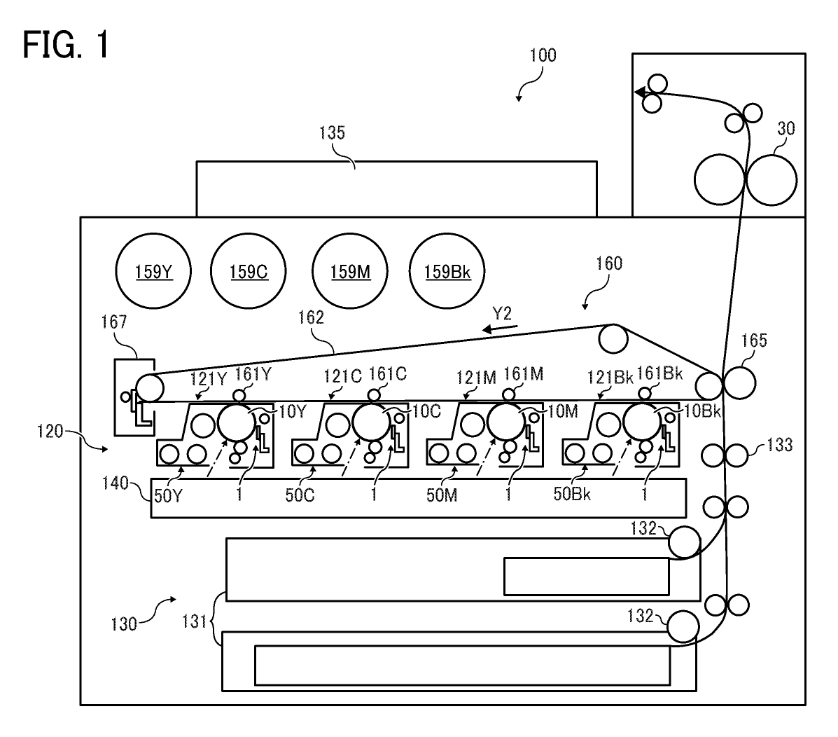

Referring now to the drawings, wherein like reference numerals designate identical or corresponding parts throughout the several views thereof, and particularly to FIG. 1, an image forming apparatus according to embodiments of the present disclosure is described. As used herein, the singular forms “a”, “an”, and “the” are intended to include the plural forms as well, unless the context clearly indicates otherwise.

Descriptions are given below of an image forming apparatus 100 (e.g., an electrophotographic printer) including a cleaning blade 5 as an example of an image forming apparatus according to an embodiment of the present disclosure.

FIG. 1 is a schematic view of the image forming apparatus 100 according to the present embodiment.

The image forming apparatus 100 is capable of forming multicolor images and includes an image forming unit 120, an intermediate transfer unit 160, and a sheet feeder 130. It is to be noted that reference characters Y, C, M, and Bk represent yellow, cyan, magenta, and black, respectively, and may be omitted in the description below when color discrimination is not necessary or when four components for yellow, magenta, cyan, and black are referred together.

The image forming unit 120 includes, from the left in FIG. 1, process cartridges 121Y, 121C, 121M, and 121Bk for yellow, cyan, magenta, and black toner, respectively. The process cartridges 121Y, 121C, 121M, and 121Bk are arranged in line in a substantially horizontal direction. The process cartridges 121Y, 121C, 121M, and 121Bk are removably insertable into a body of the image forming apparatus 100.

The intermediate transfer unit 160 includes an intermediate transfer belt 162 which is an endless belt, primary transfer rollers 161Y, 161C, 161M, and 161Bk, and a secondary transfer roller 165. The intermediate transfer belt 162 is entrained around multiple support rollers. The intermediate transfer belt 162 is positioned above the process cartridges 121Y, 121C, 121M, and 121Bk and along a direction in which drum-shaped photoconductors 10Y, 10C, 10M, and 10Bk (i.e., latent image bearers) of the process cartridges 121Y, 121C, 121M, and 121Bk rotate. The intermediate transfer belt 162 rotates in synchronization with the rotation of the photoconductors 10. The primary transfer rollers 161 are disposed along an inner circumferential face of the intermediate transfer belt 162. With the primary transfer rollers 161, the outer circumferential face of the intermediate transfer belt 162 is lightly pressed against surfaces of the photoconductors 10.

The process cartridges 121Y, 121C, 121M, and 121Bk are similar in configuration and operation to form toner images on the photoconductors 10Y, 10C, 10M, and 10Bk by developing devices 50Y, 50C, 50M, and 50Bk, respectively, and transfer the toner images onto the intermediate transfer belt 162. However, the three primary transfer rollers 161Y, 161C, and 161M corresponding to the process cartridges 121Y, 121C, and 121M for colors other than black are movable vertically with a pivot mechanism. The pivot mechanism disengages the intermediate transfer belt 162 from the photoconductors 10Y, 10C, and 10M when multicolor image formation is not performed. Additionally, a belt cleaning device 167 is disposed downstream from the secondary transfer roller 165 and upstream from the process cartridge 121Y in a direction indicated by arrow Y2 illustrated in FIG. 1, in which the intermediate transfer belt 162 rotates. The belt cleaning device 167 removes substances adhering to the intermediate transfer belt 162, such as residual toner after secondary transfer process.

Above the intermediate transfer unit 160, toner cartridges 159Y, 159C, 159M, and 159Bk for the respective process cartridges 121Y, 121C, 121M, and 121Bk are arranged substantially horizontally. Below the process cartridges 121Y, 121C, 121M, and 121Bk, an exposure device 140 is disposed. The exposure device 140 irradiates the charged surfaces of the photoconductors 10Y, 10C, 10M, and 10Bk with laser beams to form electrostatic latent images thereon.

The sheet feeder 130 is provided below the exposure device 140. The sheet feeder 130 includes sheet trays 131 for containing sheets of recording media (i.e., transfer sheets) and sheet feeding rollers 132. The sheet feeder 130 feeds transfer sheets to a secondary transfer nip formed between the intermediate transfer belt 162 and the secondary transfer roller 165 via a registration roller pair 133 at a predetermined timing.

A fixing device 30 is disposed downstream from the secondary transfer nip in a direction in which transfer sheets are transported (hereinafter “sheet conveyance direction”). Further, an ejection roller and an output tray 135 to receive transfer sheets discharged are disposed downstream from the fixing device 30 in the sheet conveyance direction.

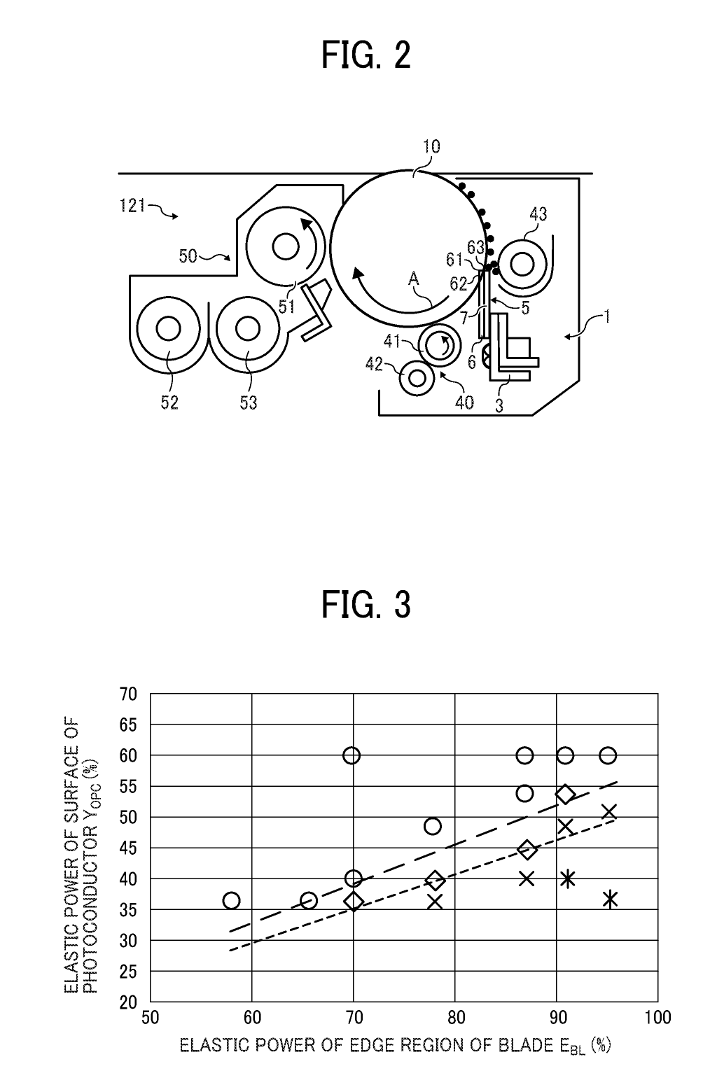

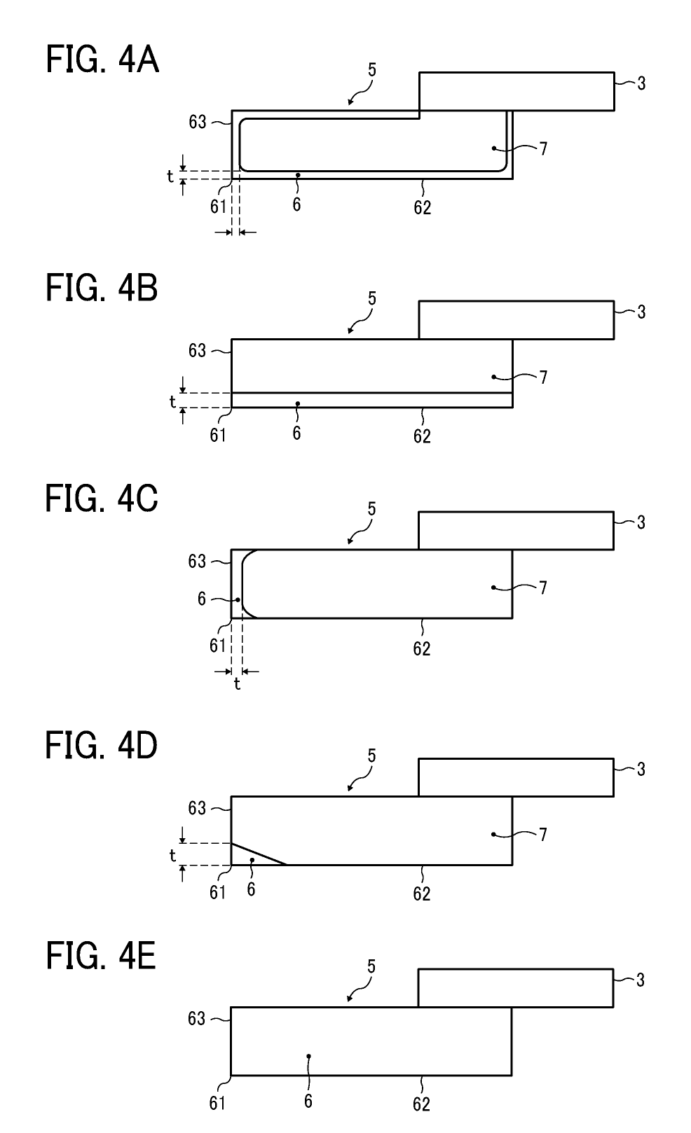

FIG. 2 schematically illustrates a configuration of the process cartridge 121 of the image forming apparatus 100. It is to be noted that the process cartridge 121 in FIG. 2 employs Blade type 2 illustrated in FIG. 4B as the cleaning blade 5.

The process cartridges 121 have a similar configuration, and therefore the subscripts Y, C, M, and Bk for color discrimination are omitted when the configuration and operation of the process cartridges 121 are described.

In addition to the drum-shaped photoconductor 10, the process cartridge 121 includes a cleaning device 1, a charging device 40, and the developing device 50 disposed around the photoconductor 10.

The cleaning device 1 includes the elastic cleaning blade 5 that is long in the axial direction of the photoconductor 10 and has a strip-like shape. The cleaning blade 5 can be single-layered or multi-layered. An edge 61 (ridgeline) of the cleaning blade 5 extends in a direction perpendicular to the direction of rotation of the photoconductor 10 (i.e., axial direction), and the edge 61 is pressed against the surface of the photoconductor 10. With the edge 61 pressed against the surface of the photoconductor 10, the cleaning device 1 removes substances, such as residual toner, from the surface of the photoconductor 10. The removed toner is discharged outside the cleaning device 1 by a discharge screw 43 of the cleaning device 1.

The charging device 40 includes a charging roller 41 disposed opposite the photoconductor 10 and a roller cleaner 42 that rotates while abutting the charging roller 41. The developing device 50 is designed to supply toner to the surface of the photoconductor 10 to develop the electrostatic latent image formed thereon into a toner image (visible image) and includes a developing roller 51 serving as a developer bearer to bear developer including carrier and toner. The developing device 50 includes the developing roller 51, a stirring screw 52, and a supply screw 53. The stirring screw 52 stirs and transports the developer contained in the developing device 50 (in particular, a developer container therein), and the supply screw 53 transports the developer while supplying the agitated developer to the developing roller 51.

The four process cartridges 121 described above can individually be installed in the body of the image forming apparatus 100 and removed therefrom by a service staff or a user. In the process cartridge 121 removed from the image forming apparatus 100, the photoconductor 10, the charging device 40, the developing device 50, and the cleaning device 1 can individually be installed to and removed from the process cartridge 121. It is to be noted that the process cartridge 121 may further includes a waste-toner tank to collect the toner removed by the cleaning device 1. In this case, it is convenient that the waste-toner tank is independently removable, installable, and replaceable from and to the process cartridge 121.

Next, operations of the image forming apparatus 100 are described below.

The image forming apparatus 100 receives print commands via a control panel of an apparatus body thereof or from external devices such as computers.

Initially, the photoconductors 10 start rotating in the direction indicated by arrow A in FIG. 2, and the charging rollers 41 charge the surfaces of the photoconductors 10 uniformly in a predetermined polarity. The exposure device 140 irradiates the charged photoconductors 10 with laser beams corresponding to respective color data. The laser beams are optically modulated according to multicolor image data input to the image forming apparatus 100. Thus, electrostatic latent images for respective colors are formed on the photoconductors 10. The developing rollers 51 of the developing devices 50 supply respective color toners to the electrostatic latent images, thereby developing the electrostatic latent images into toner images (visible images).

Subsequently, a transfer voltage opposite in polarity to the toner image is applied to the primary transfer rollers 161, thereby generating a primary-transfer electrical field between the photoconductors 10 and the primary transfer rollers 161 via the intermediate transfer belt 162. Simultaneously, the primary transfer roller 161 lightly nips (presses against) the intermediate transfer belt 162 to form the primary transfer nip. With these actions, the toner images on the respective photoconductors 10 are primarily transferred onto the intermediate transfer belt 162 efficiently. More specifically, the toner image formed on each of the photoconductors 10 is transferred primarily onto the intermediate transfer belt 162 such that the respective toner images are superimposed one atop the other, thereby forming a multilayer toner image.

Toward the multilayer toner image on the intermediate transfer belt 162, the transfer sheet is timely transported from the sheet tray 131 via the sheet feeding roller 132 and the registration roller pair 133. A transfer voltage opposite in polarity to toner images is applied to the secondary transfer roller 165, thereby forming a secondary-transfer electrical field between the intermediate transfer belt 162 and the secondary transfer roller 165 via the transfer sheet. The multilayer toner image is transferred onto the transfer sheet by the secondary-transfer electrical field. The transfer sheet carrying the multilayer toner image is transported to the fixing device 30, and the multilayer toner image is fixed on the transfer sheet by heat and pressure from the fixing device 30. The transfer sheet bearing the fixed toner image is discharged by the ejection roller to the output tray 135. After the primary transfer, toner remaining on the respective photoconductors 10 is removed by the cleaning blades 5 of the cleaning devices 1.

As illustrated in FIG. 2, the cleaning device 1 includes a blade holder 3 (support) to support a base end of the cleaning blade 5 such that the edge 61 (the ridgeline or corner at the end opposite the base end) contacts the surface of the photoconductor 10 as a contact object. The cleaning blade 5 includes an elastic blade body including the edge region 6 (edge layer) and a backup region 7 (backup layer) on the cross-section perpendicular to the edge 61 extends (i.e., double-layered blade). The edge region 6 includes the edge 61, and the backup region 7 is different in material or physical property from the edge region 6. The cleaning blade 5 according to the present embodiment is not limited to a double-layer blade (a multi-layered blade) illustrated in FIGS. 2 and 4B. The cleaning blade illustrated in FIGS. 4A to 4D including the edge region 6 and the backup region 7, which is a non-edge-region, can be used (i.e., double-region blade). Alternatively, a single-layered blade illustrated in FIG. 4E also can be used (i.e., single layered blade).

As illustrated in FIG. 2, an outer face (hereinafter “opposing face 62”) starting from the edge 61 and extending in the longitudinal direction of the cleaning blade 5 faces the downstream side in the direction of rotation of the photoconductor 10 indicated by arrow A. An end face 63 at a free end is disposed facing the upstream side from the edge 61 in the direction of rotation of the photoconductor 10. That is, in FIG. 2, the cleaning blade 5 is disposed to contact the surface of the photoconductor 10 (rotating clockwise in FIG. 2) against the direction of rotation of the photoconductor 10.

The cleaning blade 5 in which an elastic power in a vicinity of the edge region is specified may cause following problems. First, if the elastic power in the vicinity of the edge 61 is high, it is possible that toner resin or external additives adhere to and grow on the photoconductor 10, thereby causing an abnormal image. Generally, toner include external additive such as silica with size of several tens to several hundred nanometer (nm) in order to control charging ability or adhesion force. The external additives separated from toner adhere to and become aggregated substances on the photoconductor 10, thereby causing the abnormal image with white spots, that is, white spots become obvious at positions corresponding to the aggregated substances on the image. Second, if the elastic power in the vicinity of the edge 61 is low, it is possible that follow-up capability of the cleaning blade 5 with respect to unevenness of the surface of the photoconductor 10 decreases, fatigue of the cleaning blade 5 occurs, and the edge 61 of the cleaning blade 5 is chipped. Therefore, substances, such as residual toner, that pass through between the photoconductor 10 and the edge 61 increase, and cleaning capability is reduced.

More specifically, when The external additives remaining on the photoconductor 10 pass through between the photoconductor 10 and the edge 61, The external additives are rubbed against the photoconductor 10 due to sticking and slipping of the edge 61 of the cleaning blade 5. Thus, The external additives adhere to the photoconductor 10 and become aggregation on the photoconductor 10 (i.e., filming), thereby causing the abnormal image with white spots. Accordingly, the cleaning blade 5 with low elastic power of the edge region 6 can minimize occurrence of sticking and slipping and rubbing of The external additives against the photoconductor 10. In this manner, filming that causes the abnormal image with white spots can be minimized.

However, lowering the elastic power of the edge region 6 including the edge 61 is limited in order to prevent the abnormal image with white spots. If the elastic power of the entire cleaning blade 5 is low, it is possible that the follow-up capability of the cleaning blade 5 with respect to the unevenness of the surface of the photoconductor 10 decreases and the fatigue of the cleaning blade 5 occurs, thereby reducing the cleaning capability. By contrast, if the elastic power of the edge region 6 including the edge 61 is high, it is possible that the edge 61 of the cleaning blade 5 is chipped due to sticking and slipping of the edge 61, thereby causing surface filming of the photoconductor 10. Therefore, raising the elastic power of the edge region 6 is limited. The cleaning blade 5 has a permissible range between an upper limit and a lower limit of the elastic power of the edge region 6. High cleaning capability can be attained and surface filming of photoconductor 10 can be minimized by using the cleaning blade 5 within the permissible range.

Further, if a layer portion including the edge 61 is thick, the region that has low elastic power becomes wide. Accordingly, a possibility of the fatigue of the cleaning blade becomes higher. The amount of substances, such as the residual toner, passing between the photoconductor 10 and the edge 61 increases when the capability to follow the photoconductor 10 (follow-up capability) decreases, the cleaning blade fatigues, or chipping of the edge arises. Thus, the cleaning capability is degraded.

The inventor has found that, when the cleaning blades 5 having the elastic power within the permissible range cleaned the surfaces of the photoconductors 10, occurrence of surface filming of the photoconductor 10 depended on the photoconductor 10. Difference between the photoconductor 10 on which filming occurred and the photoconductor 10 on which filming did not occur was the elastic power of the surface of the photoconductor 10. As a result, the occurrence of filming relates to the elastic power of the photoconductor 10. More specifically, the inventor examined presence or absence of occurrence of the abnormal image with white spots due to filming while changing the elastic power Y_{OPC} (%) of the surface of the photoconductor 10 and the elastic power E_{BL} (%) of the edge region 6 (vicinity of the edge 61) of the cleaning blade 5. As a result, the occurrence of filming that causes the abnormal image with white spots can be minimized by satisfying Formulas A or B with proper elastic power E_{BL} (%) of the edge region 6 relative to the elastic power Y_{OPC} (%) of the photoconductor 10. Further, the inventor examined that even when the elastic power E_{BL} (%) of the edge region 6 is lower, whether the elastic power of the entire cleaning blade 5 can be kept within the proper permissible range. Therefore, the inventor found the cleaning blade 5 that can minimize the fatigue and degradation of the follow-up capability with respect to the unevenness of the surface of the photoconductor 10 due to wide area of the low elastic power.

That is, in the case in which the elastic power E_{BL} (%) of the edge region 6 is low, the elastic power of the backup region 7 other than the edge region 6 is set to high. Thus, the elasticity of the entire cleaning blade 5 that is combination of the edge region 6 and the other region is preferably set, thereby maintain the favorable cleaning capability.

In view of the foregoing, descriptions are given below of multiple configurations of the cleaning blade 5 usable in the cleaning device 1 of the image forming apparatus 100 according to the present embodiment.

Descriptions are given below of relation between the elastic power E_{BL} (%) of the edge region 6 of the cleaning blade 5 and the elastic power Y_{OPC} (%) of the surface of the photoconductor 10. As described above, lowering the elastic power E_{BL} (%) of the edge region 6 can minimize the occurrence of sticking and slipping and surface filming of the photoconductor 10. However, lowering the elastic power E_{BL} (%) of the edge region 6 is limited. If the elastic power E_{BL} (%) of the edge region 6 is excessively low, the edge 61 plastically deforms, and does not conform to the surface of the photoconductor 10, resulting in defective cleaning. Another difficulty is cutting the ridge-line of the cleaning blade 5 accurately. If accuracy of cutting of the ridge-line is low, the cleaning blade 5 is not used practically.

Therefore, the occurrence of filming that causes the abnormal image with white spots can be minimized by specifying the elastic power E_{BL} (%) of the edge region 6 with respect to the elastic power Y_{OPC} (%) of the photoconductor 10. More specifically, adhesion and growing of external additives can be minimized by raising the elastic power Y_{OPC} (%) of the photoconductor 10, without lowering the elastic power E_{BL} (%) of the edge region 6 excessively. With reference to Table 1, descriptions are given below of experiments verifying effects of the elastic power E_{BL} (%) of the edge region 6 and the elastic power Y_{OPC} (%) of the photoconductor 10 on the abnormal image with white spots. The elastic power E_{BL} (%) of the edge region 6 is measured at the opposing face 62 or the end face 63.

TABLE 1

| | Y_{OPC} | E_{BL} | Abnormal image |
|---|---|---|---|
| Condition | (%) | (%) | (White spots ) |
| (1)-1 | 56 | 70 | Very Good |
| (1)-2 | 56 | 87 | Very Good |
| (1)-3 | 56 | 91 | Very Good |
| (1)-4 | 56 | 95 | Very Good |
| (2)-1 | 50 | 87 | Very Good |
| (2)-2 | 50 | 91 | Good |
| (3)-1 | 48 | 95 | Bad |
| (4)-1 | 45 | 78 | Very Good |
| (4)-2 | 45 | 87 | Good |
| (4)-3 | 45 | 91 | Bad |
| (5)-1 | 40 | 70 | Very Good |
| (5)-2 | 40 | 78 | Good |
| (5)-3 | 40 | 87 | Bad |
| (5)-4 | 40 | 91 | Very Bad |
| (6)-1 | 37 | 58 | Very Good |
| (6)-2 | 37 | 66 | Very Good |
| (6)-3 | 37 | 70 | Good |
| (6)-4 | 37 | 78 | Bad |
| (6)-5 | 37 | 95 | Very Bad |

The occurrence of the abnormal image with white spots was evaluated under the following conditions.

As a test machine (an image forming apparatus), Ricoh MPC 3503 was used. In the test machine, the photoconductor 10 and the cleaning blade 5 of the process cartridge 121 illustrated in FIG. 2 was evaluated regarding the abnormal image with white spots while the elastic power E_{BL} (%) of the edge region 6 and the elastic power Y_{OPC} (%) of the photoconductor 10 were changed.

Evaluation conditions are given below:

Evaluation environment: under high temperature of 32° C. and high humidity of 54%

Test image: image density of 0.5%

Image output mode: 3 P/J (print per job) The job is repeated 3000 times, in which 1 job is 3 successive outputs after starting rotation of the photoconductor 10, and then the photoconductor 10 stop rotation.

The number of image outputs: 90000 sheets

Blade contact pressure (line pressure): 12 g/cm

Charging application voltage: Vp=1.7 kV

Determination criteria are given in four grades in the following manner:

Very Good: There is no substance on the photoconductor 10, no abnormal image with white spots on solid images output under temperature of 32° C. and humidity of 80%.

Good: There are few substances on the photoconductor 10, no abnormal image with white spots on solid images output under temperature of 32° C. and humidity of 80%.

Bad: Substances exist on the photoconductor 10, the abnormal image with white spots on solid images output under temperature of 32° C. and humidity of 80%.

Very Bad: Substances exist on the photoconductor 10, abnormal image with white spots on solid images output under temperature of 23° C. and humidity of 50%.

Descriptions are given below of measurement of the elastic power E_{BL} (%) of the edge region 6 and the elastic power Y_{OPC} (%) of the photoconductor 10.

Method of measuring the elastic power E_{BL} (%) of the edge region 6

Measuring instrument: HM2000 made by Fischer Instruments K.K.

Load: 1 mN

Indentation time: 10 s

Creeping time: 5 s

Measuring position: at a position 20 μm away from the edge 61 on the opposing face 62 or at a position 20 μm away from the edge 61 on the end face 63

Indenter. Vickers indenter

Measurement environment: 23° C., 50%

Method of measuring the elastic power Y_{OPC} (%) of the photoconductor 10

Measuring instrument: HM2000 made by Fischer Instruments K.K.

Load: 9.8 mN

Indentation time: 30 s

Creep time: 5 s

Unloading condition: dsqrtF/dt

Other condition: unloading condition is the same as loading condition

Measuring position: at center of the surface of the photoconductor in the axial direction (measured twice before and after rotation of 180 degrees)

Indenter: Vickers indenter

Measurement environment: 23° C., 50%

As illustrated in Table 1, the evaluations were conducted, while the elastic power E_{BL} (%) of the edge region 6 was changed from low value to high value with respect to six photoconductors 10 with the different elastic power Y_{OPC} (i.e., 56%, 50%, 48%, 45%, 40%, and 37%). For example, evaluation results are illustrated in Table 1 of the highest elastic power Y_{OPC} (%) of the six photoconductors 10 (56%) in conditions (1)-1, (1)-2, (1)-3, and (1)-4, (i.e., the elastic power E_{BL} (%) of the edge region 6 was changed in order of 70%, 87%, 91%, and 95%). As the results, in the case of the high elastic power Y_{OPC} (%) of the photoconductor 10 (56%), the abnormal image with white spots did not occur by the high elastic power E_{BL} (%) Of the edge region 6.

By contrast, for example, evaluation results are illustrated in Table 1 of the lowest elastic power Y_{OPC} (%) of the six photoconductors 10 (37%) in conditions (6)-1, (6)-2, (6)-3, (6)-4, and (6)-5, (i.e., the elastic power E_{BL} (%) of the edge region 6 was changed in order of 58%, 66%, 70%, 78%, and 95%). As the results, in the case of low elastic power Y_{OPC} (%) of the photoconductor 10 (37%), the abnormal image with white spots was evaluated as very good, and did not occur at the elastic power E_{BL} (%) of the edge region 6 of 58% and 66%. The abnormal image with white spots was evaluated as good, and did not occur at the elastic power E_{BL} (%) of the edge region 6 of 70%. However, as the elastic power E_{BL} (%) of the edge region 6 became higher, like 78% and 95%, the evaluation of the abnormal image with white spots became worse, like bad and very bad. That is, according to results in the conditions (1)-1 through (6)-5, raising elastic power Y_{OPC} (%) of the photoconductor 10 can prevent the abnormal image with white spots without lowering the elastic power E_{BL} (%) of the edge region 6.

The inventor examined relation between the occurrence of the abnormal image with white spots and the elastic power E_{BL} (%) and Y_{OPC} (%) base on Table 1.

In FIG. 3, horizontal axis represents the elastic power E_{BL} (%) of the edge region 6, and vertical axis represents the elastic power Y_{OPC} (%) of the photoconductor 10. In FIG. 3, a circle marker represents “Very Good”, a diamond marker represents “Good”, a cross marker represents “Bad”, and an asterisk marker represents “Very Bad” as evaluation results of the abnormal image with white spots.

The relation between the occurrence of the abnormal image with white spots and the elastic power E_{BL} (%) and Y_{OPC} (%) was derived from evaluation results in conditions (4)-2 and (5)-2, which is not a problem in practical use (i.e., “Good”). As a result, region of “Good” is expressed as the following Formula A.

Y_{OPC}≥0.55×E_{BL}−3.33 Formula A

That is, the elastic power E_{BL} (%) of the edge region 6 is prescribed so that the elastic power E_{BL} and Y_{OPC} (%) satisfy Formula A (i.e., area above a dotted line indicating Formula A in FIG. 3). Therefore, the abnormal image with white spots does not occur due to adhesion and aggregation of the external additives on the surface of the photoconductor 10.

The relation between the occurrence of the abnormal image with white spots and the elastic power E_{BL} (%) and Y_{OPC} (%) was derived from evaluation results in conditions (2)-1 and (6)-2, in which there is not substance on the photoconductor 10, and there is no problem in practical use (i.e., “Very Good”). As a result, region of “Very Good” is expressed as the following Formula B.

Y_{OPC}≥0.61×E_{BL}−3.85 Formula B

That is, the elastic power E_{BL} (%) of the edge region 6 is prescribed so that the elastic power E_{BL} (%) and Y_{OPC} (%) satisfy the Formula B (i.e., area above a dashed line indicating Formula B in FIG. 3). Therefore, the abnormal image with white spots does not occur due to adhesion and aggregation of the external additives on the surface of the photoconductor 10.

As described above, the cleaning blade 5 is formed so that the elastic power EEL (%) of the edge region 6 satisfies Formulas A or B. Therefore, the cleaning blade 5, the cleaning device 1, the image forming apparatus 100, and the process cartridge 121 can minimize filming to the photoconductor 10 causing the abnormal image with white spots.

The inventor examined relation of a surface roughness Rz and the elastic power E_{BL} (%) of the edge region 6 when the elastic powers E_{BL} (%) and Y_{OPC} (%) satisfy Formulas A or B. As a result, the inventor found that the unevenness of the surface of the photoconductor 10 reduces area of contact with the cleaning blade 5 and minimizes frequency that the cleaning blade 5 rubs The external additives of toner against the surface of the photoconductor 10 to minimize the abnormal image with white spots.

However, if the surface roughness Rz of the photoconductor 10 is excessively large, the edge 61 of the cleaning blade 5 may be locally chipped by the unevenness of the surface of the photoconductor 10, resulting in increase of toner that slips through the cleaning blade 5 and the defective cleaning. Accordingly, the inventor examined an upper limit and a lower limit of the surface roughness Rz of the surface of the photoconductor 10 that does not cause the abnormal image with white spots in order to control the unevenness of the surface of the photoconductor 10.

The results are indicated in Table 2.

TABLE 2

| condition | (2)-2 | | (2)-1 | | (6)-3 | | (6)-1 | |
|---|---|---|---|---|---|---|---|---|
| h_{OPC} | 200 | | 200 | | 200 | | 200 | |
| (N/mm²) | | | | | | | | |
| Y_{OPC} (%) | 50 | | 50 | | 37 | | 37 | |
| E_{BL} (%) | 91 | | 87 | | 70 | | 58 | |
| Rz | Abnormal | Defective | Abnormal | Defective | Abnomial | Defective | Abnormal | Defective |
| (μm) | image | cleaning | image | cleaning | image | cleaning | image | cleaning |
| 0.05 | Bad | Very | Good | Very | Bad | Very | Good | Very |
| | | Good | | Good | | Good | | Good |
| 0.1 | Good | Very | Very | Very | Good | Very | Very | Very |
| | | Good | Good | Good | | Good | Good | Good |
| 0.3 | Very | Very | Very | Very | Very | Very | Very | Very |
| | Good | Good | Good | Good | Good | Good | Good | Good |
| 0.5 | Very | Very | Very | Very | Very | Very | Very | Very |
| | Good | Good | Good | Good | Good | Good | Good | Good |
| 0.6 | Very | Very | Very | Very | Very | Very | Very | Very |
| | Good | Good | Good | Good | Good | Good | Good | Good |
| 0.7 | Good | Good | Good | Good | Good | Good | Good | Good |
| 0.8 | Good | Good | Good | Good | Bad | Bad | Bad | Bad |
| 0.9 | Good | Good | Bad | Bad | Bad | Bad | Very | Very |
| | | | | | | | Bad | Bad |
| 1.0 | Bad | Bad | Bad | Bad | Very | Very | Very | Very |
| | | | | | Bad | Bad | Bad | Bad |
| 1.1 | Bad | Bad | Very | Very | Very | Very | Very | Very |
| | | | Bad | Bad | Bad | Bad | Bad | Bad |

With combination of the photoconductors 10 and the cleaning blades 5 in conditions (2)-1, (2)-2, (6)-1, and (6)-3, the inventor examined the occurrences of the abnormal image with white spots and the defective cleaning, using the photoconductor 10 with the surface roughness Rz of 0.05 m to 1.1 μm. The photoconductors 10 and the cleaning blades 5 in conditions (2)-2 and (6)-3 satisfy Formula A, and the photoconductors 10 and the cleaning blades 5 in conditions (2)-1 and (6)-1 satisfy Formula B. A Martens hardness hope of the surface of the photoconductor 10 is approximately 200 N/mm². The evaluation conditions and the determination criteria are the same as above-described experiments indicated in Table 1. Evaluation of the defective cleaning is made in four grades in the following manner. After 90000 image prints as the same in the experiments indicated in Table 1, occurrence of the defective cleaning was confirmed.

Very Good: After outputs of 90000 sheets, there is no abnormal image due to defective cleaning on the output image, and toner slip through is not visually observed on the surface of the photoconductor 10.

Good: After outputs of 90000 sheets, there is no abnormal image due to defective cleaning on the output image, and slight toner slip through is visually observed on the surface of the photoconductor 10. It is to be noted that the toner on the photoconductor 10 is easily blown off with air or the like to be removed.

Bad: After outputs of 90000 sheets, there is an abnormal image due to defective cleaning on the output image, and obvious toner slip through is visually observed on the surface of the photoconductor 10. It is to be noted that the toner on the photoconductor 10 is blown off with air or the like to be removed.

Very Bad: After outputs of 90000 sheets, there is an abnormal image due to defective cleaning on the output image, and obvious toner slip through is visually observed on the surface of the photoconductor 10. Additionally, the toner adhere the surface of the photoconductor 10 and is not easily blown off with air or the like to be removed.

From the results of Table 2, in the case in which Formula A is satisfied, when the surface roughness Rz of the photoconductor 10 is 0.05 μm, the evaluation of the abnormal image is bad. Further, from the results of Table 1, by lowering the elastic power E_{BL} (%) of the edge region 6 of the cleaning blade 5, even when the elastic power Y_{OPC} (%) of the surface of the photoconductor 10 is low, it is possible to minimize the occurrence of the abnormal image with white spots.

However, from the results of Table 2, in a case where the elastic power E_{BL} (%) of the edge region 6 of the cleaning blade 5 is low, as the surface roughness Rz of the photoconductor 10 increases, local abrasion of the edge region 6 of the cleaning blade 5 occurs, resulting in the defective cleaning. This is because that if the elastic power EEL (%) of the edge region 6 of the cleaning blade 5 is excessively low, the edge 61 of the cleaning blade 5 does not slide following the unevenness of the surface of the photoconductor 10, the edge 61 is thereby gouged by the unevenness of the surface of the photoconductor 10. That is, the lower limit of the surface roughness Rz of the photoconductor 10 is determined in order to minimize the occurrence of the abnormal image with white spots, and the upper limit of the surface roughness Rz of the photoconductor 10 is determined in order to minimize the occurrence of the defective cleaning.

According to Table 2, the surface roughness Rz of the photoconductor 10 is set to 0.1 μm or more and 0.7 μm or less when formula A or formula B is satisfied. As a result, both the evaluation of the abnormal image with white spots and the evaluation of the defective cleaning are at least good, and it is possible to satisfactorily minimize the occurrence of the abnormal image with white spots and the occurrence of the defective cleaning. Furthermore, according to Table 2, the surface roughness Rz of the photoconductor 10 is set to 0.3 μm or more and 0.6 μm or less when Formula A or Formula B is satisfied. As a result, both the evaluation of the abnormal image with white spots and the evaluation of the defective cleaning are very good, and it is possible to more satisfactorily minimize the occurrence of the abnormal image with white spots and the occurrence of the defective cleaning.

Next, the Martens hardness hope of the surface of the photoconductor 10 is described.

It is known that the greater the Martens hardness h_{OPC} of the surface of the photoconductor 10 is, the smaller the abrasion of the surface of the photoconductor 10 is. Therefore, as the Martens hardness hope of the surface of the photoconductor 10 is set to high, the surface roughness Rz of the photoconductor 10 can be maintained from the beginning and with time. As a result, it is possible to minimize the occurrence of filming on the surface of the photoconductor 10, which is the cause of the occurrence of the abnormal image with white spots, from the beginning and with time. When the external additives of the toner pass between the photoconductor 10 and the cleaning blade 5, the external additives contact the photoconductor 10 and the cleaning blade 5. Therefore, when the Martens hardness h_{OPC} of the surface of the photoconductor 10 is excessively high, the cleaning blade 5 is more easily ground by the external additives than the photoconductor 10, and abrasion of the cleaning blade is promoted. Such abrasion of the cleaning blade 5 is not local abrasion due to the large surface roughness Rz of the photoconductor 10 as described in Table 2, but uniform abrasion the longitudinal direction. As the amount of uniform abrasion increases, the defective cleaning is likely to occur.

The following Table 3 illustrates results of evaluation of the occurrence of the abnormal image with white spots and the defective cleaning after outputs of 90000 sheets when the surface roughness Rz of the photoconductor 10 and the Martens hardness h_{OPC} of the surface of the photoconductor 10 are changed while the photoconductor 10 and the cleaning blade 5 satisfy Formula A. The experimental method is the same method of the experiment illustrated in Table 1. In addition, the determination criteria for the abnormal image with white spots and the defective cleaning are the same as the criteria in Tables 1 and 2. In Table 3, the evaluation results using the photoconductor 10 and the cleaning blade 5 satisfying the Formula A are described, but in the case of using the photoconductor 10 and the cleaning blade 5 satisfying the Formula B, similar evaluation results can be obtained.

TABLE 3

| h_{OPC} | 160 or more and | | 190 or more and | | 310 or more and | | | |
|---|---|---|---|---|---|---|---|---|
| (N/mm²) | less than 190 | | less than 310 | | less than 350 | | 350 or more | |
| YOPC (%) | 50 | | 50 | | 50 | | 50 | |
| E_{BL} (%) | 91 | | 91 | | 91 | | 91 | |
| Rz | Abnormal | Defective | Abnormal | Defective | Abnormal | Defective | Abnormal | Defective |
| (μm) | image | cleaning | image | cleaning | image | cleaning | image | cleaning |
| 0.1 | Bad | Very | Good | Very | Good | Good | Good | Bad |
| | | Good | | Good | | | | |
| 0.3 | Good | Very | Very | Very | Very | Good | Very | Bad |
| | | Good | Good | Good | Good | | Good | |
| 0.5 | Good | Very | Very | Very | Very | Good | Very | Bad |
| | | Good | Good | Good | Good | | Good | |

As illustrated in Table 3, when the surface roughness Rz of the photoconductor 10 is 0.1 μm and the Martens hardness h_{OPC} of the surface of the photoconductor 10 is 160 N/mm² or more and less than 190 N/mm², the unevenness of the surface of the photoconductor 10 become smaller due to abrasion, and the evaluation of the abnormal image with white spots is bad. It is to be noted that the cleaning capability is maintained (i.e., very good). When the Martens hardness h_{OPC} of the surface of the photoconductor 10 is 190 N/mm² or more and less than 350 N/mm², the evaluation of abnormal image with white spots does not change until after outputs of 90000 sheets from the initial, and the evaluation of the abnormal image with white spots is good, the evaluation of the defective cleaning is also at least good, and the cleaning capability is maintained. When the Martens hardness h_{OPC} of the surface of the photoconductor 10 is 350 N/mm² or more, although the evaluation of the abnormal image with white spots is good, the evaluation of the defective cleaning becomes bad and the cleaning capability is degraded.

Additionally, as illustrated in Table 3, when the surface roughness Rz of the photoconductor 10 is 0.3 μm or 0.5 μm and the Martens hardness h_{OPC} of the surface of the photoconductor 10 is 160 N/mm² or more and less than 190 N/mm², the evaluation of the abnormal image with white spots is good, the evaluation of the defective cleaning is very good, and the cleaning capability is maintained. When the Martens hardness h_{OPC} of the surface of the photoconductor 10 is 190 N/mm² or more and less than 310 N/mm², the abnormal image with white spots does not occur, the cleaning capability is not degraded, and the determinations of the abnormal image with white spots and the defective cleaning are very good. When the Martens hardness h_{OPC} of the surface of the photoconductor 10 is 310 N/mm² or more and less than 350 N/mm², compared with when the Martens hardness h_{OPC} of the surface of the photoconductor 10 is smaller than 310 N/mm², the cleaning capability is degraded, and the evaluation of defective cleaning is good. However, when the Martens hardness h_{OPC} of the surface of the photoconductor 10 is 350 N/mm² or more, the cleaning capability further decreases as compared with when the Martens hardness h_{OPC} of the surface of the photoconductor 10 is smaller than 350 N/mm², and the evaluation of defective cleaning is bad.

From the above-described results, it can be seen from Table 3 that when the Martens hardness h_{OPC} of the surface of the photoconductor 10 is set to 190 N/mm² or more and less than 350 N/mm², the surface roughness Rz of the photoconductor 10 can be maintained with time. Therefore, it is possible to minimize the occurrence of filming on the surface of the photoconductor 10, which causes the occurrence of the abnormal image with white spots, and the occurrence of the defective cleaning with time. In addition, it can be seen from Table 3 that when the Martens hardness h_{OPC} of the surface of the photoconductor 10 is set to 190 N/mm² or more and less than 310 N/mm², the occurrence of filming, which causes the occurrence of the abnormal image with white spots, and the occurrence of defective cleaning can be minimized more favorably with time.

Furthermore, in the case of satisfying Formula A or Formula B, depending on the value of the elastic power Y_{OPC} (%) of the surface of the photoconductor 10, the elastic power E_{BL} (%) of the edge region 6 of the cleaning blade 5 may be set to a low value. In such a case, as described above, there is a possibility that deterioration of the follow-up capability with respect to the unevenness of the surface of the contact object to be cleaned, degradation of the cleaning capability, such as blade fatigue, edge chipping, or the like, may occur. In particular, when the setting value of the elastic power E_{BL} (%) of the edge region 6 of the cleaning blade 5 is low, the cleaning capability may prominently decreases in the cleaning blade 5 of the single-layer structure (Blade type 5) illustrated in FIG. 4E. When the elastic power E_{BL} (%) of the edge region 6 of the cleaning blade 5 is low, the cleaning blade 5 having a two-region structure illustrated in FIGS. 4A, 4B, 4C and 4D is used. Therefore, the cleaning device 1, the image forming apparatus 100, and the process cartridge 121 are provided that can minimize degradation of the cleaning capability. Examples of the cleaning blades 5 of types 1 to 4 illustrated in FIGS. 4A, 4B, 4C, and 4D are described below.

### Embodiment 1

Next, Embodiment 1 is described.

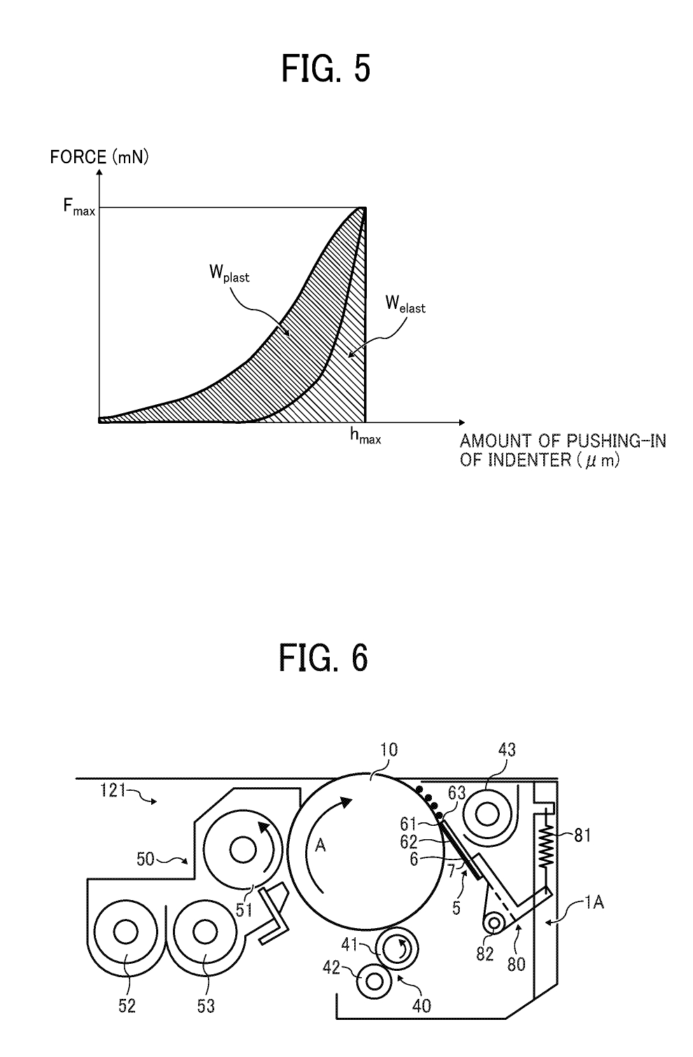

FIGS. 4A to 4E are cross-sectional views of shapes of the cleaning blade 5 usable in Embodiment 1 and illustrates types of cross-section of the elastic blade body perpendicular to the edge 61 extends. FIG. 5 is a graph of cumulative stress while a Vickers intender is pushed to the depth hmax, and cumulative stress in removal of a test load.

FIG. 4A illustrates Blade type 1, in which the edge region 6 extends along the circumference of the cleaning blade 5. The edge region 6 surrounds the backup region 7 except the portion connected to the blade holder 3. In Blade type 2 illustrated in FIG. 4B, the edge region 6 shaped like a layer extends along the opposing face 62 facing the photoconductor 10. FIG. 4C illustrates Blade type 3, in which the edge region 6 extends along the end face 63 including the edge 61 and adjoining the opposing face 62. FIG. 4D illustrates Blade type 4, in which the edge region 6 is a triangular region defined by the edge 61, a point on the end face 63, and a point on the opposing face 62. FIG. 4E illustrates Blade type 5, in which the blade is single layered.

Here, as illustrated in FIGS. 4A to 4D, the thickness t of the layered portion including the edge 61 is the thickness of the portion of the edge region 6 predetermined before deformation for each type.

More specifically, in the cleaning blade 5 of type 1 illustrated in FIG. 4A, the thickness t is the thickness of the layered portion of the opposing face 62 side facing the photoconductor 10 and the thickness of the layered portion on the end face 63 side in the edge region 6 provided along the outer periphery of the cleaning blade 5. In FIG. 4A, a leader line of the reference “t” is given to the thickness of the layer-like portion including the edge 61 on the side of the opposing face 62 and the end face 63.

In Blade type 2 illustrated in FIG. 4B, the edge region 6 shaped like a layer extending along the opposing face 62 (to face the photoconductor 10) has the thickness t. In Blade type 3 illustrated in FIG. 4C, the edge region 6 including the edge 61 and the end face 63 (adjacent to the opposing face 62) has the thickness t. In Blade type 4 illustrated in FIG. 4D, the triangular edge region 6 defined by the point on the edge 61, the point on the end face 63, and the point on the opposing face 62 has the thickness t on the end face 63.

As described above, the cleaning blade 5 of the present embodiment has a single-layer structure (one region structure) made of the elastic blade body formed only by the edge region including the edge 61 illustrated in FIG. 4E. Alternatively, the cleaning blade 5 is the elastic blade body with two-region structure including the edge region 6 and the backup region 7 on the cross-section perpendicular to the edge 61 extends. The edge region 6 includes the edge 61, and the backup region 7 is different in material or physical property from the edge region 6 illustrated in FIGS. 4A to 4D.

The elastic power is a characteristic value obtained as follows.

Wₑₗₐₛₜ/Wₜₒₜₐₗ×100%, where Wₜₒₜₐₗ represents the cumulative stress caused while the Vickers indenter is pushed in, and Wₑₗₐₛₜ represents the cumulative stress caused in removal of the test load. The total work (cumulative stress caused while the Vickers indenter is pushed in) is sum of work by plastic deformation and work by elastic deformation as expressed by Wₜₒₜₐₗ=Wₚₗₐₛₜ+Wₑₗₐₛₜ (see FIG. 5).

As the elastic power increases, the rate of plastic work in the period from application of force to distort the material to remove the load becomes smaller. That is, plastic deformation is not likely to occur when rubber is deformed by force.

### Embodiment 2

According to Embodiment 2, the cleaning blade 5 usable in the cleaning device 1 of the above-described image forming apparatus 100 is described.

The cleaning blade 5 according to the present embodiment is different from the cleaning blade 5 according Embodiment 1 in that the relation between an elastic power E_{BL-A} (%) of the edge region 6 and an elastic power E_{BL-B} (%) of the backup region 7 is specified.

Therefore, descriptions of structures similar to Embodiment 1, and action and effects thereof are omitted appropriately. Unless it is necessary to distinguish, the same reference characters are given to the same or similar elements in descriptions below.

The cleaning blade 5 for removing substances on the photoconductor 10 is configured so that the elastic power E_{BL-B} (%) of the backup region 7 is greater than the elastic power E_{BL-A} (%) of the edge region 6. In the cleaning blade 5, in order to prevent filming, it is advantageous to set the elastic power E_{BL-A} (%) of the edge region 6 to low. In such a case, there is a possibility that deterioration of the follow-up capability with respect to the unevenness of the surface of the photoconductor 10, degradation of the cleaning capability, such as blade fatigue, edge chipping, or the like, may occur.

Therefore, in the cleaning blade 5 according to Embodiment 2, the elastic power E_{BL-B} (%) of the backup region 7 is set to be larger than the elastic power E_{BL-A} (%) of the edge region 6, and the edge region 6 and the backup region 7 are configured so as to maintain elasticity of the entire cleaning blade 5. Accordingly, it is possible to ensure the follow-up capability of the entire cleaning blade 5 to the unevenness of the surface of the photoconductor 10, and to minimize the occurrence of blade fatigue and edge chipping, thereby ensuring the favorable cleaning capability.

### Embodiment 3

According to Embodiment 3, the cleaning blade 5 usable in the cleaning device 1 of the above-described image forming apparatus 100 is described.

The cleaning blade 5 according to the present embodiment is different from the cleaning blade 5 according to Embodiment 1 in that the relation between a Martens hardness h_{A} (N/mm²) of the edge region 6 and a Martens hardness h_{B} (N/mm²) of the backup region 7 is specified.

Therefore, descriptions of structures similar to Embodiment 1, and action and effects thereof are omitted appropriately. Unless it is necessary to distinguish, the same reference characters are given to the same or similar elements in descriptions below.

When the backup region 7 is higher in hardness than the edge region 6, the capability of the cleaning blade 5 to follow the surface unevenness of the photoconductor 10 is degraded. Then, there is the risk that toner escapes the cleaning blade 5, that is, passes through the clearance between the photoconductor 10 and the edge 61. Further, since the edge 61 included in the edge region 6 has a lower hardness than the backup region 7, chipping may occur in the edge 61 due to sticking and slipping.

Therefore, in the cleaning blade 5 of Embodiment 3, it is specified that the Martens hardness h_{A} (N/mm²) of the edge region 6 is configured to be larger than the Martens hardness h_{B} (N/mm²) of the backup region 7.

Thus, when the edge region 6 has a higher hardness than the hardness of the backup region 7, escaping residual substances as well as chipping of the edge 61 due to sticking and slipping can be minimized.

### Embodiment 4

According to Embodiment 4, the cleaning blade 5 usable in the cleaning device 1 of the above-described image forming apparatus 100 is described.

FIG. 6 is a schematic view illustrating the process cartridge 121 employed in the image forming apparatus 100 according to Embodiment 4. It is to be noted that the process cartridge 121 in FIG. 6 employs Blade type 2 illustrated in FIG. 4B as the cleaning blade 5.

The cleaning device 1 and the cleaning blade 5 of Embodiment 4 are different from the cleaning devices 1 and the cleaning blade 5 of Embodiments 1 to 3 only in respect of the following points. That is, in Embodiments 1 to 3, the blade holder 3 supporting the cleaning blade 5 is secured to the cleaning device 1. By contrast, the cleaning device 1 according to Embodiment 4 includes a rotatable blade holder 80 to support the cleaning blade 5 and a spring 81 to urge the blade holder 80 to the photoconductor 10. In other words, the cleaning device 1 according to Embodiment 4 employs spring pressure using the force of the spring 81 (constant contact-pressure type) to press the edge 61 of the cleaning blade 5 to the photoconductor 10.

Therefore, descriptions of structures similar to Embodiments 1 to 3, and action and effects thereof are omitted appropriately. Unless it is necessary to distinguish, the same reference characters are given to the same or similar elements in descriptions below.

In the above-described cleaning device 1 in which the cleaning blades 5 according to Embodiments 1 to 3 are usable, as illustrated in FIG. 2, the cleaning blade 5 is secured in a state in which the edge 61 of the cleaning blade 5 is pressed toward the photoconductor 10 (hereinafter “pressurized-state attachment”). In the pressurized-state attachment in which the cleaning blade 5 being in the pressed state is secured, the line pressure of the edge 61 abutting against the photoconductor 10 significantly decreases when the cleaning blade 5 fatigues, even though the degree of fatigue is small. Accordingly, the substances, such as the residual toner are likely to pass between the photoconductor 10 and the edge 61 of the cleaning blade 5, resulting in the defective cleaning.

By contrast, a cleaning device 1A according to Embodiment 4 uses the force of the spring 81 (spring pressure) to press the edge 61 of the cleaning blade 5 to the photoconductor 10, as illustrated in FIG. 6. Accordingly, such spring pressure inhibits a significant decrease in the line pressure on the edge 61 abutting against the photoconductor 10 and maintains approximately constant line pressure even if the cleaning blade 5 fatigues. That is, in the constant contact-pressure type cleaning device 1A using the force of the spring 81, even if the cleaning blade 5 fatigues, the line pressure does not drop significantly, and the defective cleaning hardly occurs.

Specifically, the spring pressure of the cleaning blade 5 is attained by the following structure. As illustrated in FIG. 6, the blade holder 80 has a rotation support 82, serving as a rotation axis. Due to the tension of the spring 81 (e.g., a tension spring), the blade holder 80 rotates or pivots around the rotation support 82 to press the edge 61 of the cleaning blade 5 to the photoconductor 10.

In addition, the cleaning blade 5 according to Embodiment 4 is a two-region blade similar to the cleaning blades 5 according to Embodiments 1 to 3, to inhibit the fatigue of the cleaning blade 5.

With the above-described feature of the cleaning device 1A, decreases in the line pressure are minimized, thereby inhibiting the defective cleaning.

Next, other features of the image forming apparatus 100 are described in detail below.

Initially, in the present embodiment, the charging device 40 to uniformly charge the surface of the photoconductor 10 is described with reference to FIG. 2.

Use of a contact-type charger (e.g., a charging roller 41) to apply superimposed voltage including direct current (DC) voltage and alternating current (AC) voltage to uniformly charge the surface of the image bearer, such as the photoconductor 10, is advantageous in that a charging current is greater and the potential of the charged image bearer becomes more reliable. Then, image quality is enhanced and the operational life of the apparatus is expanded.

However, when the AC voltage is applied to the contact-type charging roller 41, the unevenness appears on the surface of the photoconductor 10, which is inconvenient for cleaning the photoconductor 10. Specifically, when the unevenness appears on the surface of the photoconductor 10, the capability of the edge 61 of the cleaning blade 5 to follow the unevenness of the surface of the photoconductor 10 decreases. Alternatively, the cleaning blade 5 fatigues or is chipped. Then, the amount of the substances, such as the residual toner, passing between the photoconductor 10 and the edge 61 increases.

By contrast, in the image forming apparatus 100 according to the present embodiment, use of the above-described two-region cleaning blade 5 can inhibit the degradation of capability of the cleaning blade 5 to follow the unevenness of the surface of the photoconductor 10 and the fatigue and chipping of the cleaning blade 5. Accordingly, even in the configuration in which the contact-type charging roller 41 applies the AC voltage to the photoconductor 10, the cleaning capability of the cleaning blade 5 is less degraded by the unevenness of the surface of the photoconductor 10.

That is, even in the image forming apparatus 100 having the contact type charging roller 41 as the charger to uniformly charge the photoconductor 10, use of the cleaning blade 5 of each embodiment can minimize degradation of the cleaning capability of the cleaning blade 5 due to the unevenness of the surface of the photoconductor 10.

If the amount of the substances passing between the photoconductor 10 and the edge 61 increases due to the application of AC current to the charger (the charging roller 41) of the charging device 40, the charging roller 41 is soiled with the residual toner or The external additives, resulting in the abnormal image.

On the other hand, in the image forming apparatus 100 according to the present embodiment, use of the cleaning blade 5 which is the blade having the two-region structure according to each of the above-described embodiments can minimize amount of substances passing through between the photoconductor 10 and the edge 61, such as the residual toner and additives. With this configuration, even when the charging device 40 that applies the AC voltage to the surface of the photoconductor 10 is used, it is possible to minimize the occurrence of the abnormal image due to contamination of the charging roller 41.

That is, use of the cleaning blade 5 of each embodiment, even in the image forming apparatus 100 having the charging device 40 to apply the alternating current to the photoconductor 10, can minimize the occurrence of the abnormal image due to contamination of the charging roller 41.

Next, the photoconductor 10 used in the image forming apparatus 100 is described in further detail below.

The photoconductor 10 of the present embodiment includes at least a photosensitive layer 92 on a conductive support 91, and further, a resin surface layer including inorganic particles dispersed therein and other arbitrarily layers as needed.

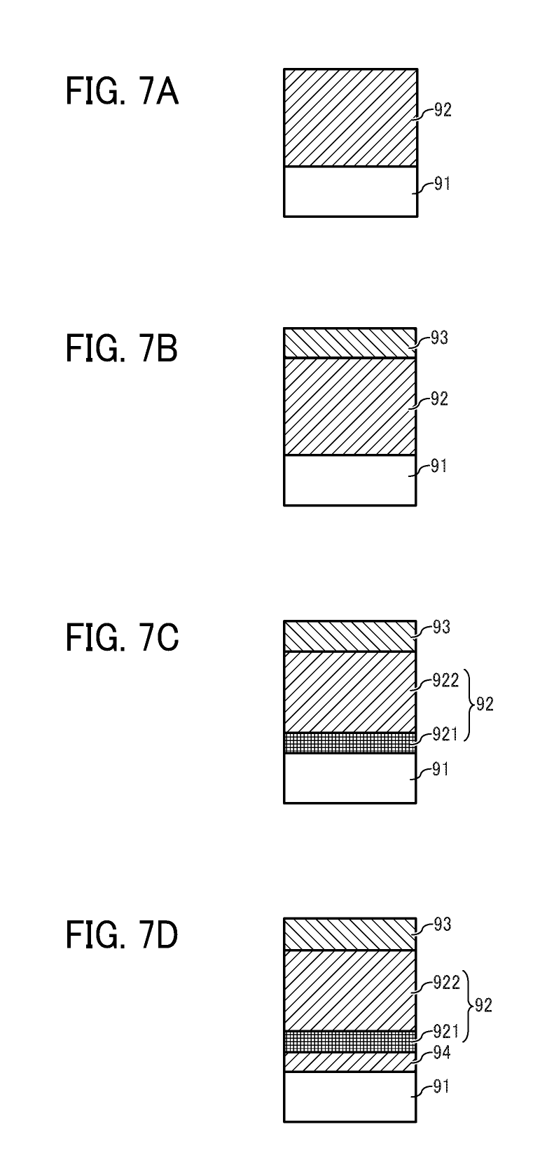

First, the layer structure of the photoconductor 10 is described with reference to FIGS. 7A to 7D.

In the layer structure illustrated in FIG. 7A, the photoconductor 10 includes a conductive support 91 and the photosensitive layer 92 overlaying the conductive support 91, and inorganic particles are present at or adjacent to the surface of the photosensitive layer 92. In the layer structure illustrated in FIG. 7B, the photoconductor 10 includes the conductive support 91 and the photosensitive layer 92 on the conductive support 91, and a surface layer 93 including inorganic particles. FIG. 7C illustrates a layer structure including, from the bottom, the conductive support 91, the photosensitive layer 92, and the surface layer 93 including inorganic particles; and the photosensitive layer 92 is constructed of a charge generation layer 921 and a charge transport layer 922. FIG. 7D illustrates a layer structure including, from the bottom, the conductive support 91, an undercoat layer 94, the photosensitive layer 92 constructed of the charge generation layer 921 and the charge transport layer 922, and the surface layer 93 including inorganic particles.

There is no specific limit to the selection of materials for use in the conductive support 91 which have a volume resistance of not greater than 10¹⁰ Ωcm. For example, usable examples include plastic or paper having a film-like form or cylindrical form covered with a metal such as aluminum, nickel, chrome, nichrome, copper, gold, silver, and platinum, or a metal oxide such as tin oxide and indium oxide by vapor deposition or sputtering. Alternatively, a board formed of aluminum, an aluminum alloy, nickel, and a stainless steel can be used. Moreover, a tube which is manufactured from the board mentioned above by a crafting technique such as extruding and extracting and surface-treatment such as cutting, super finishing, and grinding is also usable. In addition, an endless nickel belt and an endless stainless steel belt such as those disclosed in JP S52-036016-B1 can be used as the conductive support 91.

In addition, the conductive support 91 can be produced by coating the above-described conductive support 91 with binder resin in which conductive powder is dispersed. Specific examples of the conductive powder include, but are not limited to, carbon black, acetylene black, powders of metals such as aluminum, nickel, iron, nichrome, copper, zinc, and silver, and powders of metal oxides such as conductive tin oxides and ITO (indium tin oxide). Specific examples of the binder resins which are used in combination with the electroconductive powder include, but are not limited to, thermoplastic resins, thermosetting resins, and light curable resins, such as a polystyrene, a styrene-acrylonitrile copolymer, a styrene-butadiene copolymer, a styrene-maleic anhydride copolymer, a polyester, a polyvinyl chloride, a vinyl chloride-vinyl acetate copolymer, a polyvinyl acetate, a polyvinylidene chloride, a polyarylate (PAR) resin, a phenoxy resin, polycarbonate, a cellulose acetate resin, an ethyl cellulose resin, a polyvinyl butyral, a polyvinyl formal, a polyvinyl toluene, a poly-N-vinyl carbazole, an acrylic resin, a silicone resin, an epoxy resin, a melamine resin, an urethane resin, a phenolic resin, and an alkyd resin.

The conductive layer can be formed by applying a coating liquid dispersing or dissolving the conductive powder and the binder resin in a solvent (e.g., tetrahydrofuran, dichloromethane, methyl ethyl ketone, or toluene), on the support.

Examples of the conductive support 91 further include cylindrical supports coated with a heat-shrinkable tube, as a conductive layer, made of polyvinyl chloride, polypropylene, polyester, polystyrene, polyvinylidene chloride, polyethylene, chlorinated rubber, or TEFLON (trademark) further dispersing conductive powder therein.

Next, the photosensitive layer 92 is described below.

The photosensitive layer 92 can employ a single-layer structure or a laminate structure. A structure of the charge generation layer 921 and the charge transport layer 922 are described later for convenience.

The charge generation layer 921 includes a charge generation material as a main ingredient. Specific examples of the charge generation material in the charge generation layer 921 include, but are not limited to, monoazo pigments, disazo pigments, trisazo pigments, perylene pigments, perinone pigments, quinacridone pigments, quinone condensed polycyclic compounds, squaric acid dyes, phthalocyanine pigments, naphthalocyanine pigments, and azulenium salt dyes. These charge generation materials can be used alone or in combination.

In particular, azo pigments and phthalocyanine pigments are effective. In particular, titanyl phthalocyanine is effectively used that have a maximum diffraction peek at least at 27.2° as Bragg's law 20 diffraction peak (±0.2°) against CuKα characteristic X-ray (wavelength 1.514 Å).

The charge generation layer 921 can be formed by dispersing the charge generation material and an optional binder resin in a suitable solvent using a ball mill, an attritor, a sand mill, or ultrasonic and applying the liquid dispersion to the conductive support 91 followed by drying.

Specific examples of the binder resin optionally used in the charge generation layer 921 include, but are not limited to, polyamides, polyurethanes, epoxy resins, polyketones, polycarbonates, silicone resins, acrylic resins, polyvinylbutyrals, polyvinylformals, polyvinylketones, polystyrenes, polysulfone, poly-N-vinylcarbazoles, polyacrylamides, polyvinyl benzale, polyester, phenoxy resin, copolymer of vinylchloride and vinyl acetate, polyvinyl acetate, polyphenylene oxide, polyamide, polyvinylpyridine, cellulose-based resin, casein, polyvinyl alcohol, and polyvinyl pyrolidone.

The content of the binder resin is from 0 parts by weight to 500 parts by weight and preferably from 10 parts by weight to 300 parts by weight based on 100 parts by weight of the charge generation material.

Specific examples of the solvents include, but are not limited to, isopropanol, acetone, methylethylketone, cyclohexanone, tetrahydrofuran, dioxane, ethylcellosolve, ethyl acetate, methylacetate, dichloromethane, dichloroethane, monochlorobenzene, cyclohexane, toluene, xylene, and ligroin. Among these, ketone-based solvents, ester-based solvents, and ether-based solvents are preferably used.

The coating liquid may be coated by dip coating, spray coating, bead coating, nozzle coating, spinner coating, or ring coating. Preferably, the charge generation layer 921 has a film thickness of about 0.01 to 5 μm, more preferably 0.1 to 2 μm. The charge transport layer 922 is formed by dissolving or dispersing a charge transport material and binder resin in a suitable solvent and applying the resultant liquid dispersion to the charge generation layer 921 followed by drying. As required, a plasticizer, a leveling agent, an antioxidant, and the like may be added thereto. The charge transport material is classified as hole transport material or electron transport material.

Specific examples of the electron transport material include, but are not limited to, electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and benzoquinone derivatives. Specific examples of the hole transport materials include, but are not limited to, poly-N-vinylcarbazol and derivatives thereof, poly-γ-carbzoyl ethylglutamate) and derivatives thereof, pyrenne-formaldehyde condensation products and derivatives thereof, polyvinylpyrene, polyvinyl phenanthrene, polysilane, oxazole derivatives, oxadiazole derivatives, imidazole derivatives, monoaryl amine derivatives, diaryl amine derivatives, triaryl amine derivatives, stilbene derivatives, α-phenyl stilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives, and other known materials.

These charge transport materials may be used alone or in combination.

Specific examples of usable binder resins include thermoplastic and thermosetting resins, such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinylcarbazole, acrylic resin, silicone resin, epoxy resin, melamine resin, urethane resin, phenol resin, and alkyd resin.

The content of the charge transport material is from 20 parts by weight to 300 parts by weight and preferably from 40 parts by weight to 150 parts by weight based on 100 parts by weight of the binder resin. The film thickness of the charge transport layer 922 is preferably equal to or smaller than 25 μm from the viewpoint of resolution and response. Although the lower limit depends on the property (charging voltage in particular) of the system used, the lower limit is preferably 5 μm or more. The solvent usable here can be tetrahydrofuran, dioxan, toluene, dichloromethane, monochlorobenzene, dichloroethane, cyclohexanone, methyl ethyl ketone, acetone, or the like. In the photoconductor 10 of the present embodiment, the plasticizer or the leveling agent is optionally added to the charge transport layer 922. Known plasticizers, for example, dibutyl phthalate and dioctyl phthalate, can be used as the plasticizers. A suitable usage amount of the plasticizer is from 0 to about 30% by weight to the binder resin. As the leveling agent, silicone oil such as dimethyl silicone oil and methylphenyl silicone oil; polymer having a perfluoroalkyl group as lateral chains; or oligomers can be used. The weight ratio of the leveling agent to the binder resin is within a range from 0 to 1% by weight to the binder resin.

When the charge transport layer 922 serves as the surface layer, inorganic particles are included in the charge transport layer 922. Examples of inorganic particles include metal powder such as copper, tin, aluminum, and indium; metal oxide such as silicon oxide, silica, tin oxide, zinc oxide, titanium oxide, indium oxide, antimony oxide, bismuth oxide, tin oxide in which antimony is doped, and indium oxide in which tin is doped; and inorganic material such as potassium titanate. Metal oxide is particularly preferable, and further silicon oxide, aluminum oxide, and titanium oxide are effective.

Inorganic particles preferably have an average primary particle diameter ranging from 0.01 μm to 0.5 μm, considering the characteristics of the surface layer 93 such as light transmittance and abrasion resistance. The abrasion resistance and the degree of dispersion decrease when the average primary particle diameter is 0.01 μm or smaller. Additionally, when the average primary particle diameter is 0.5 μm or greater, inorganic particles in the dispersion liquid can sink more easily, and toner surface filming of the photoconductor 10 can occur.

As the amount of inorganic particles added increases, abrasion resistance increases, which is desirable. However, if the amount of inorganic particles is extremely large, residual potentials may rise, and the degree at which writing light transmits the surface (protective) layer 93 may decrease, resulting in side effects. Generally, the amount of addition to the total solid amount is preferably 30% by weight or smaller, and more preferably 20% by weight or smaller. The lower limit is generally 3% by weight.

The above-described inorganic particles can be treated with at least one surface treatment agent, which is preferable for facilitating the dispersion of inorganic particles.

When inorganic particles are poorly dispersed in the surface layer 93, the following problems may occur. These are: (1) the residual potential of a resultant photoconductor 10 increases; (2) the transparency of a resultant surface layer decreases; (3) coating defects occur in a resultant surface layer 93; and, (4) the anti-abrasion property of the surface layer 93 deteriorates. These possibly develop into greater problems with regard to the durability of a resultant photoconductor 10, and the quality of the images produced thereby.

The case in which the photosensitive layer 92 having a single-layer structure is described next.

The photoconductor 10 in which the charge generation material described above is dispersed in a binder resin can be used. The single photosensitive layer 92 can be formed by dissolving or dispersing the charge generation materials, the charge transport materials, and the binder resins in a suitable solvent followed by coating and drying.

It is to be noted that when the single photosensitive layer 92 is the surface layer, the photosensitive layer 92 includes the above-described inorganic particles. Further, the photosensitive layer 92 may be a function separation type to which the above-described charge transport material is added, and can be favorably used. In addition, the plasticizer, the leveling agent, the antioxidant, or the like can be added, if desired. In addition to the binder resin specified for the charge transport layer 922, the binder resin specified for the charge generation layer 921 can be mixed for use.

The content of the charge generation material is preferably from 5 parts by weight to 40 parts by weight and the content of the charge transport material is preferably from 0 parts by weight to 190 parts by weight and more preferably from 50 parts by weight to 150 parts by weight based on 100 parts by weight of the binder resin. The single photosensitive layer 92 can be formed by applying a liquid application in which the charge generation material and the binder resin, in addition if desired, the charge transport material, are dispersed in a solvent such as tetrahydrofuran, dioxane, dichloroethane, or cyclohexane by a dispersing machine using dip coating, spray coating, bead coating, or ring coating.

The film thickness of the single photosensitive layer 92 is suitably from about 5 μm to about 25 μm.

In the photoconductor 10 of the present embodiment, the undercoat layer 94 can be provided between the conductive support 91 and the photosensitive layer 92.

Typically, such the undercoat layer 94 is mainly made of resin. Considering that the photosensitive layer 92 is formed thereon in a form of solvent, the resin is preferably not or rarely soluble in known organic solvents.

Specific examples of such resins include, but are not limited to, water-soluble resins, such as polyvinyl alcohol, casein, and sodium polyacrylate; alcohol soluble resins, such as copolymerized nylon and methoxymethylated nylon; and curable resins which form a three dimension mesh structure, such as polyurethane, melamine resins, phenolic resins, alkyd-melamine resins, and epoxy resins.

In addition, fine powder pigments of a metal oxide, such as titanium oxides, silica, alumina, zirconium oxides, tin oxides, and indium oxides can be added to the undercoat layer 94 to prevent moiré and reduce the residual potential. The undercoat layer 94 described above can be formed by using a suitable solvent and a suitable coating method as described above for the photosensitive layer 92. Silane coupling agents, titanium coupling agents, and chromium coupling agents can be used as the undercoat layer 94. Furthermore, the undercoat layer 94 can be formed by using a material formed by anodizing Al₂O₃, or an organic compound, such as polyparaxylylene (parylene) or an inorganic compound, such as SiO₂, SnO₂, TiO, ITO, and CeO₂ by a vacuum thin-film forming method. Any other known materials and methods can be also available.

The film thickness of the undercoat layer 94 is suitably 1 to 5 μm.

The photoconductor 10 of the present embodiment can includes the surface layer 93 including inorganic particles above the photosensitive layer 92.

The surface layer 93 includes at least inorganic particles and binder resin. Examples of binder resin include thermoplastic resin such as polyarylate resin and polycarbonate resin; and cross-linking resin such as urethane resin and phenolic resin.

The fine particles can be either organic or inorganic. Examples of organic particles include fluorine containing resin particles and carbonaceous particles. Examples of inorganic particles include metal powder such as copper, tin, aluminum, and indium; metal oxide such as silicon oxide, silica, tin oxide, zinc oxide, titanium oxide, indium oxide, antimony oxide, bismuth oxide, tin oxide in which antimony is doped, and indium oxide in which tin is doped; and inorganic material such as potassium titanate. Metal oxide is particularly preferable, and further silicon oxide, aluminum oxide, and titanium oxide are effective.

Inorganic particles preferably have the average primary particle diameter ranging from 0.01 μm to 0.5 μm, considering the characteristics of the surface layer 93 such as light transmittance and abrasion resistance. The abrasion resistance and the degree of dispersion decrease when the average primary particle diameter is 0.01 μm or smaller. Additionally, when the average primary particle diameter is 0.5 μm or greater, inorganic particles in the dispersion liquid can sink more easily, and toner surface filming of the photoconductor 10 can occur.

When the concentration (percentage) of inorganic particles in the surface layer 93 is large, abrasion resistivity is high, which is desirable. An extremely large amount of inorganic particles, however, causes increases in residual potentials and decreases in the degree at which writing light transmits the surface (protective) layer 93, and side effects may arise. Generally, the amount of addition to the total solid amount is preferably 50% by weight or smaller, and more preferably 30% by weight or smaller. The lower limit is generally 5% by weight. The above-described inorganic particles can be treated with at least one surface treatment agent, which is preferable for facilitating the dispersion of inorganic particles. When inorganic particles are poorly dispersed in the surface layer 93, the following problems may occur. These are: (1) the residual potential of a resultant photoconductor 10 increases; (2) the transparency of a resultant surface layer 93 decreases; (3) coating defects occur in the resultant surface layer 93; and, (4) the abrasion resistance of the surface layer 93 deteriorates. These possibly develop into greater problems with regard to the durability of the resultant photoconductor 10, and the quality of the images produced thereby.

Typical surface treatment agents can be used, but surface treatment agents capable of maintaining insulation of inorganic particles are preferable. For example, titanate coupling agents, aluminum coupling agents, zircoaluminate coupling agents, higher fatty acids, mixtures of silane coupling agents and those, Al₂O₃, TiO₂, ZrO₂, silicone, aluminum stearate, and mixtures of two or greater of them are preferable as the surface treatment agent to attain preferable dispersion of inorganic particles and inhibition of image blurring.

Treatment on inorganic particles by the silane coupling agent has an adverse impact with regard to production of blurred images. However, a combinational use of the surface treatment agent specified above and the silane coupling agent may lessen this adverse impact.

The amount of surface treatment is preferably within a range from 3% by weight to 30% by weight and, more preferably, from 5% by weight to 20% by weight although it depends on the average primary particle diameter of inorganic particles. If the amount of surface treatment is smaller than the range, dispersion of inorganic particles is insufficient, and, if the amount of surface treatment is extremely large, the residual potential can rise significantly. The above-mentioned inorganic particles can be used alone or in combination.

The film thickness of the surface layer 93 is preferably within a range from 1.0 μm to 8.0 μm.

Since the photoconductor 10 is repeatedly used for a long time, the photoconductor 10 has a high mechanical durability and does not easily abrade. Inside the image forming apparatus 100, the charging roller 41 produces ozone and NOₓ gas, and such gas tends to adhere to the surface of the photoconductor 10, resulting in image deletion. To prevent image deletion, it is necessary to abrade the surface layer 93 (or the photosensitive layer 92) at a predetermined rate. Therefore, it is preferred that the surface layer 93 have a film thickness of 1.0 μm or greater for the repeated use for a long time. In addition, when the film thickness of the surface layer 93 is larger than 8.0 μm, the residual potential may rise and a micro dot reproducibility may be lowered.

The material of inorganic particles can be dispersed by using a suitable dispersing machine. The average particle size of inorganic particles in the dispersion liquid is preferably 1 μm or smaller and, more preferably, 0.5 μm or smaller considering the light transmittance of the surface layer 93.

Known methods such as dip coating, ring coating, spray coating, or the like can be used as the application method to coat the surface layer 93 on the photosensitive layer 92. Among these methods, a typical method for forming the surface layer 93 is the spray coating in which the coating material is ejected as mist from nozzles having micro openings, and micro droplets of the mist adhere to the photosensitive layer 92, forming a coating layer. The solvent usable here can be tetrahydrofuran, dioxan, toluene, dichloromethane, monochlorobenzene, dichloroethane, cyclohexanone, methyl ethyl ketone, acetone, or the like.

The surface layer 93 can include the charge transport material to reduce the residual potential and improve the response. Materials similar to those used for the charge transport layer 922 can be used as the charge transport material added here. When low-molecular charge transport materials are used as the charge transport material, there can be a density inclination in the surface layer 93.

Further, polymeric charge transport materials having both capabilities of the charge transport material and binder resin can be preferably used in the surface layer 93. The surface layer 93 formed of such polymeric charge transport materials have excellent abrasion resistance. Known materials can be used as the polymeric charge transport material, and it is preferably at least a polymer selected from polycarbonate, polyurethane, polyester, and polyether. In particular, polycarbonate having a triarylamine structure in the main chain, side chain, or both is preferable.

The elastic power or the Martens hardness of the surface layer 93 of the photoconductor 10 is appropriately controlled by the addition amount of inorganic particles and the resin type. The elastic power and the Martens hardness of resins such as polycarbonate and polyarylate increase by incorporating a rigid structure into the resin skeleton. Additionally, use of the polymeric charge transport material can enhance the elastic power and the Martens hardness.

Next, toner usable in the image forming apparatus 100 according to the present embodiment is described below using drawings.

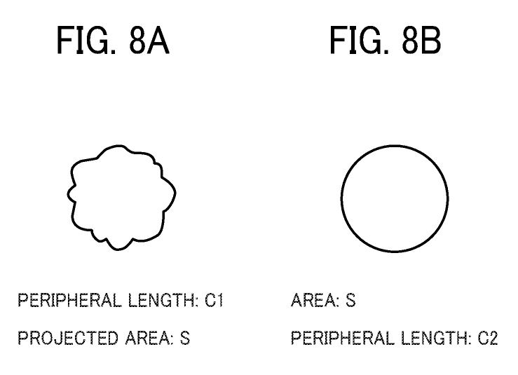

FIGS. 8A and 8B are illustrations of measurement of circularity of toner particles. FIG. 8A schematically illustrates a peripheral length C1 of a projected shape of a toner particle having an area S. FIG. 8B illustrates a peripheral length C2 of a perfect circle having an area identical to the area S of the projected shape illustrated in FIG. 8A.

In the image forming apparatus 100 of the present embodiment, to improve image quality, it is preferable to use polymerized toner produced by suspension polymerization, emulsion polymerization, or dispersion polymerization, which is suitable for enhancing circularity and reducing particle diameter. Particularly, a polymerized toner having a circularity of 0.97 or higher and a volume average particle diameter of 5.5 μm or less is suitably used. High resolution can be attained by use of polymerized toner having an average circularity of 0.97 or higher and the volume average particle diameter of 5.5 μm or smaller.

The circularity used herein is the average circularity measured by a flow-type particle image analyzer FPIA-2000 of SYSMEX CORPORATION. The average circularity is measured as follows. As a dispersant, put 0.1 ml to 0.5 ml of surfactant, preferably alkylbenzene sulfonate, in 100 ml to 150 ml of water from which impure solid materials are previously removed, and add 0.1 g to 0.5 g of the sample (toner) to the mixture. Thereafter, suspension in which the toner is dispersed is subjected to an ultrasonic dispersion treatment for about 1 to about 3 minutes such that the concentration of the liquid dispersion is 3,000 to 10,000 particles per micro litter, and the resultant is set in the instrument mentioned above to measure the form and the distribution of the toner.

Based on the measurement results, obtain C2/C1 wherein C1 represents the peripheral length of the projected toner particle having the area S illustrated in FIG. 8A, and C2 represents the peripheral length of the perfect circle illustrated in FIG. 8B, identical in area with the projected toner particle. The average of C2/C1 is used as the circularity.

The volume average particle diameter of toner can be measured by a coulter counter method. Specifically, number distribution and volume distribution of toner, measured by Coulter Multisizer™ 2e from Beckman Coulter, are output, via an interface from Nikkaki Bios Co., Ltd., to a computer and analyzed. More specifically, the volume average particle diameter of toner is obtained as follows. Prepare, as an electrolyte, a NaCl aqueous solution including a first-grade sodium chloride of 1%. Initially, 0.1 ml to 5 ml of surfactant, preferably alkylbenzene sulfonate, is added as dispersant to 100 ml to 150 ml of the electrolyte. Furthermore, add 2 to 20 mg of the toner sample to be measured followed by dispersion by an ultrasonic dispersion device for about 1 to 3 minutes.

Subsequently, put 100 ml to 200 ml of the electrolyte solution in a separate beaker, and put the above-described sample therein to attain a predetermined concentration. Then, using Coulter Multisizer™ 2e, measure the particle diameter of 50,000 toner particles with an aperture of 100 μm.

The number of channels used in the measurement is 13. The ranges of the channels are from 2.00 μm to less than 2.52 μm, from 2.52 μm to less than 3.17 μm, from 3.17 μm to less than 4.00 μm, from 4.00 μm to less than 5.04 μm, from 5.04 μm to less than 6.35 μm, from 6.35 μm to less than 8.00 μm, from 8.00 μm to less than 10.08 μm, from 10.08 μm to less than 12.70 μm, from 12.70 μm to less than 16.00 μm, from 16.00 μm to less than 20.20 μm, from 20.20 μm to less than 25.40 μm, from 25.40 μm to less than 32.00 μm, from 32.00 μm to less than 40.30 μm. The range to be measured is set from 2.00 μm to less than or equal to 32.0 μm. The volume average particle diameter is calculated using the following relation:

Volume Average Particle Diameter=ΣXfV/ΣfV,

wherein X represents a representative diameter in each channel, V represents an equivalent volume of the representative diameter in each channel, and f represents the number of particles in each channel.

It is to be understood that, within the scope of the appended claims, the disclosure of this patent specification may be practiced otherwise than as the configurations including the cleaning blade 5 or the cleaning device 1 (or 1A) specifically described herein.

The exemplary embodiments described above are one example and attain advantages below in a plurality of Aspects A to K.

Aspect A

A cleaning blade 5 includes an elastic blade body. The elastic blade body having an edge 61 contacts a surface of a contact object such as a photoconductor 10. The cleaning blade 5 removes substances on the surface of the contact object that moves in contact with the edge 61. An elastic power E_{BL} of the cleaning blade 5 satisfying a relation expressed by Formula A with respect to an elastic power Y_{OPC} of the contact object.

Y_{OPC}≥0.55×E_{BL}−3.33 Formula A

The elastic power is used as an index representing the elasticity of an elastic blade body made of an elastic material, not a rebound resilience generally widely used as an elasticity of elastic materials. The elastic power is not a macroscopic value like the rebound resilience but a property obtained by measuring the elasticity of a minute region using a micro-hardness tester, and suitable as an index of the ease of occurrence of sticking and slipping in a minute area such as the vicinity of the edge 61. When the elastic power of the cleaning blade 5 is low, sticking and slipping at the edge 61 of the cleaning blade 5 is less likely to occur. By contrast, when the elastic power of the cleaning blade 5 is high, sticking and slipping at the edge 61 of the cleaning blade 5 is likely to occur. Furthermore, the elastic power is used as an index representing the magnitude of plastic deformation of the photoconductor 10 as the contact object to be cleaned. When the elastic power is low, plastic deformation of the photoconductor 10 is likely to occur, whereas when the elastic power of the photoconductor 10 is high, plastic deformation of the photoconductor 10 is difficult to occur.

Generally, the cleaning blade 5 with low elastic power of the elastic blade body can minimize the occurrence of sticking and slipping at the edge 61 and does not rub The external additives against the photoconductor 10, thereby minimizing the occurrence of filming and the abnormal image with white spots. Therefore, cleaning capability can be enhanced. However, when the elastic power of the elastic blade body exceeds a certain value (lower limit), the follow-up capability of the elastic blade body to the unevenness of the surface of the photoconductor 10 are lowered, substances such as residual toner on the surface of the photoconductor 10 is likely to pass through between the surface of the photoconductor 10 and the edge 61 of the elastic blade body, thereby lowering the cleaning capability. Therefore, there is a limit to lowering the elastic power of the elastic blade body. On the other hand, by increasing the elastic power of the elastic blade body, the follow-up capability of the elastic blade body to the unevenness of the surface of the photoconductor 10 is enhanced, and the substances on the surface of the photoconductor 10 are less likely to pass through between the surface of the photoconductor 10 and the edge 61 of the elastic blade body, thereby improving the cleaning capability. However, when the elastic power of the elastic blade body exceeds a certain value (upper limit), substances are rubbed against the surface of the photoconductor due to sticking and slipping at the edge 61 of the elastic blade body, filming occurs on the surface of the photoconductor 10. Therefore, there is a limit to increasing the elastic power of the elastic blade body. As described above, the elastic power of the elastic blade body has a permissible range determined by the upper limit value and the lower limit value. Therefore, The occurrence of filming on the surface of the photoconductor 10 can be minimized while realizing a high cleaning capability by using the elastic blade body having the elastic power within the permissible range.

Furthermore, as described above, the inventor found that when the cleaning blades 5 within the permissible range cleaned the surfaces of the photoconductors 10, the occurrence of surface filming of the photoconductor 10 depended on the photoconductor 10. Difference between the photoconductor 10 on which filming occurred and the photoconductor 10 on which filming did not occur was the elastic power of the surface of the photoconductor 10. As a result, the inventor found that the occurrence of filming relates to the elastic power of the photoconductor 10. Therefore, the inventor changed the elastic power of the surface of the photoconductor 10 and the elastic power of the elastic blade body and examined the occurrence of the abnormal image with white spots due to filming on the surface of the photoconductor 10. As a result, the inventor found that when the surface of the photoconductor 10 was cleaned using the elastic blade body having the elastic power within the permissible range, the photoconductor 10 having low elastic power of the surface of the photoconductor was 10 more likely to have the abnormal image with white spots. It is presumed as follows. A part of the substances such as residual toner blocked by the elastic blade body may sneak between the surface of the photoconductor 10 and the elastic blade body and slip through the gap. At that time, a part of the substances is pressed against the surface of the photoconductor 10 by the elastic force of the elastic blade body, and the pressed surface of the photoconductor 10 is recessed. Since the surface of the photoconductor 10 is likely to be plastically deformed, a portion of the surface of the photoconductor 10, which is recessed by the part of the substances, remains in a substantially recessed state even after passing through the cleaning position by the elastic blade body. As a result, even after passing through the cleaning position, the part of the substances that has slipped through between the surface of the photoconductor 10 and the elastic blade body is present in the recession of the surface of the photoconductor 10. As a result, it is presumed that the edge 61 of the elastic blade is hard to contact the substances in the recess, and it becomes difficult to scrape off substances in the recess. On the contrary, as the photoconductor 10 having high elastic power of the surface of the photoconductor 10, the abnormal image with white spots became less likely to occur. Since the surface of the photoconductor 10 is less likely to be plastically deformed, the portion of the surface of the photoconductor 10, which is recessed by the part of the substances, returns to the state before being pressed after passing through the cleaning position by the elastic blade body. As a result, it is presumed that the edge 61 of the cleaning blade 5 is liable to contact the substances on the surface of the photoconductor 10, and the cleaning capability is enhanced.

The inventor found that when the relation between the elastic power of the surface of the photoconductor 10 and the elastic power of the elastic blade body satisfies Formula A obtained based on the experimental result of the above described embodiment, the occurrence of filming on the surface of the photoconductor 10 can be satisfactorily minimized. According to this aspect, when filming occurs using the elastic blade body having the elastic power within the permissible range described above, the elastic power E_{BL} (%) of the elastic blade body is set to satisfy Formula A with respect to the elastic power Y_{OPC} (%) of the surface of the photoconductor 10. Therefore, even when filming occurs using the elastic blade body having the elastic power within the permissible range described above, the cleaning blade 5 are provided that can minimize filming to the photoconductor 10 causing the abnormal image with white spots.

Aspect B

A cleaning blade 5 includes an elastic blade body. The elastic body having an edge 61 contacts a surface of a contact object such as a photoconductor 10. The cleaning blade 5 removes substances on the surface of the contact object that moves in contact with the edge 61. An elastic power E_{BL} of the cleaning blade 5 satisfying a relation expressed by Formula B with respect to an elastic power Y_{OPC} of the contact object.

Y_{OPC}≥0.61×E_{BL}−3.85 Formula B

According to this aspect, as a result of the experiment of the above embodiment, it is found that as the relation between the elastic power of the surface of the photoconductor 10 and the elastic power of the elastic blade body satisfies Formula B, the occurrence of filming of the surface of the photoconductor 10 can be more satisfactorily minimized as compared with the case where Formula A of the aspect A is satisfied.

In this embodiment, the elastic blade body is configured so that the elastic power E_{BL} (%) of the elastic blade body satisfies Formula B with respect to the elastic power Y_{OPC} (%) of the surface of the photoconductor 10. Therefore, it is possible to provide a cleaning blade 5 capable of further minimizing the occurrence of filming of the surface of the photoconductor 10 as compared with the aspect A.

Aspect C

In Aspect A or B, surface roughness Rz of the contact object is 0.1 μm or more and 0.7 μm or less.

The photoconductor 10 as the contact object was cleaned by using the cleaning blade 5 having the elastic power E_{BL} (%) satisfying Formula A or Formula B. At that time, the inventor noticed that there was the occurrence of the abnormal image with white spots also due to a certain magnitude of the surface roughness Rz of the photoconductor 10. Therefore, the inventor examined that the presence or absence of the abnormal image with white spots when the value of the surface roughness Rz of the photoconductor 10 satisfying Formula A or Formula B is changed with respect to the elastic power E_{BL} (%) of the cleaning blade 5 satisfying Formula A or Formula B. As a result, the inventor understood the following things. That is, the unevenness of the surface of the photoconductor 10 prevents the cleaning blade 5 from contacting the entire bottom of the recess, so that the contact area with the surface of the photoconductor 10 decreases, and then the cleaning blade 5 is less likely to rub additives of toner against the surface of the photoconductor 10. As a result, since sticking and slipping can be minimized, filming that causes the abnormal image with white spots can be minimized. However, if the surface roughness Rz of the photoconductor 10 is excessively large, the edge 61 of the cleaning blade 5 may be locally chipped by the unevenness of the surface of the photoconductor 10, resulting in increase of toner that slips through the cleaning blade 5 and the defective cleaning. Therefore, there is a limit to increasing the surface roughness Rz of the photoconductor 10. As described above, the surface roughness Rz of the photoconductor 10 has a permissible range determined by the lower limit value and the upper limit value. As the photoconductor 10 having the surface roughness Rz within the permissible range is cleaned using the cleaning blade 5 satisfying Formula A or Formula B, it is possible to minimize the occurrence of both of filming on the surface of the photoconductor 10 and the abnormal image with white spots.

According to this aspect, as a result of experiments different from the experiments corresponding to Aspect A or Aspect B, when the surface roughness Rz of the contact object was not less than 0.1 μm and not more than 0.7 μm, the occurrence of filming on the surface of the photoconductor 10 and the occurrence of the defective cleaning was satisfactorily minimized, which is the cause of occurrence of the abnormal image with white spots.

In this aspect, since the surface roughness of contact object is not less than 0.1 μm and not more than 0.7 μm, it is possible to minimize the occurrence of both of filming on the surface of the photoconductor 10, which is caused the abnormal image with white spots, and the defective cleaning.

Aspect D

In Aspect A or B, surface roughness Rz of the contact object is not less than 0.3 μm and not more than 0.6 μm.

According to this aspect, as a result of experiments different from the experiments on the aspect A or aspect B, for example, when the surface roughness Rz of the photoconductor 10 as the contact object was 0.3 μm or more and 0.6 μm or less, the occurrence of filming on the surface of the photoconductor 10 and the occurrence of defective cleaning, which are the cause of occurrence of the abnormal image with white spots, were more satisfactorily minimized as compared with the aspect C.

In this aspect, since the surface roughness of contact object is not less than 0.3 μm and not more than 0.6 μm, it is possible to minimize the occurrence of both of filming on the surface of the photoconductor 10, which is caused the abnormal image with white spots, and the defective cleaning.

Aspect E

In Aspect A or B, a Martens hardness h_{OPC} of the surface of the contact object is 190 N/mm² or more and less than 350 N/mm².

In general, for example, when the Martens hardness h_{OPC} of the surface of the photoconductor 10 as the contact object is small, the surface roughness Rz of the photoconductor 10 is reduced due to abrasion by the cleaning blade 5 and the surface roughness Rz of the photoconductor 10 may become less than the lower limit of the permissible range of the surface roughness Rz. On the other hand, as the Martens hardness h_{OPC} of the surface of the photoconductor 10 is greater, the abrasion of the surface of the photoconductor 10 becomes smaller. Therefore, by setting the Martens hardness h_{OPC} of the surface of the photoconductor 10 to be higher, the surface roughness Rz of the photoconductor 10 is maintained within the permissible range. However, when the external additive of the toner passes between the photoconductor 10 and the edge 61 of the cleaning blade 5, the external additive contacts the photoconductor 10 and the cleaning blade 5. Therefore, when the Martens hardness h_{OPC} of the surface of the photoconductor 10 is excessively large, the edge 61 of the cleaning blade 5 is more likely to be chipped than the photoconductor 10 by the external additive, and abrasion of the cleaning blade 5 is promoted. As described above, if the Martens hardness h_{OPC} of the surface of the photoconductor 10 has a permissible range determined by the lower limit value and the upper limit value, and the Martens hardness h_{OPC} of the surface of the photoconductor 10 is within the permissible range, the surface roughness Rz is considered to be within the permissible range over time.

Therefore, the inventor examined that the occurrence of the abnormal image with white spots and the defective cleaning while the Martens hardness h_{OPC} of the photoconductor 10 satisfying Formula A or Formula B was changed with respect to the cleaning blade 5 satisfying Formula A or Formula B. As a result, it was found that the surface roughness Rz of the photoconductor 10 was maintained with time because the Martens hardness h_{OPC} on the surface of the photoconductor 10 was 190 N/mm² or more and less than 350 N/mm².

In this aspect, since the Martens hardness h_{OPC} of the surface of the photoconductor 10 is 190 N/mm² or more and less than 350 N/mm², it is possible to prevent the occurrence of filming on the surface of the photoconductor 10, which causes the abnormal image with white spots, and the occurrence of defective cleaning can be minimized with time.

Aspect F

In Aspect A or B, a Martens hardness h_{OPC} of the surface of the contact object is 190 N/mm² or more and less than 310 N/mm².

According to this aspect, as a result of experiments, it is found that, for example, since the Martens hardness h_{OPC} of the surface of the photoconductor 10 as the contact object was 190 N/mm² or more and less than 310 N/mm², the occurrence of filming on the surface of the photoconductor 10 and the occurrence of defective cleaning, which are the cause of occurrence of the abnormal image with white spots, were more satisfactorily minimized as compared with the aspect E.

In this aspect, since the Martens hardness hope of the surface of the photoconductor 10 is 190 N/mm² or more and less than 310 N/mm², it is possible to prevent the occurrence of filming on the surface of the photoconductor 10, which causes the abnormal image with white spots, and the occurrence of defective cleaning can be minimized with time.

Aspect G

In Aspect A or B, the cleaning blade 5 includes an edge region 6 including the edge 61 and a non-edge region (backup region 7) other than the edge region 6 on the cross-section perpendicular to the edge 61 extends. The non-edge region (backup region 7) is different in at least one of material and physical property from the edge region 6. An elastic power of the edge region 6 is smaller than an elastic power of the non-edge region (backup region 7).

In the cleaning blade 5 for removing substances on the photoconductor 10 as the contact object, it is advantageous to set the elastic power of the edge region 6 of the cleaning blade 5 to be low in order to prevent filming. However, in such a case in which the elastic power of the edge region 6 of the cleaning blade 5 is low, there is a possibility that deterioration of follow-up capability with respect to the unevenness of the surface of the contact object to be cleaned, degradation of cleaning capability, such as blade fatigue, edge chipping, or the like, may occur. Therefore, by setting the elastic power of the non-edge region (backup region 7) other than the edge region 6 to be high and maintaining the elasticity of the entire cleaning blade 5 including the edge region 6 and the non-edge region (backup region 7), the follow-up capability of the cleaning blade 5 to the unevenness of the surface of the contact object can be maintained, and the fatigue and edge chipping of the cleaning blade can be prevented, resulting in the satisfactory cleaning capability.

Aspect H

In Aspect A or B, the cleaning blade 5 includes an edge region 6 including the edge 61 and a non-edge region (backup region 7) other than the edge region 6 on the cross-section perpendicular to the edge 61 extends. The non-edge region (backup region 7) is different in at least one of material and physical property from the edge region 6. A Martens hardness of the edge region 6 is greater than a Martens hardness of the non-edge region (backup region 7).

In the cleaning blade 5 to remove substances on the photoconductor 10, when the backup region 7 is higher in hardness than the edge region 6, the capability of the cleaning blade 5 to follow the unevenness of the surface of the photoconductor 10 is degraded. Then, there is the risk that toner escapes the cleaning blade 5, that is, passes through the clearance between the photoconductor 10 and the edge 61. Further, since the edge region 6 including the edge 61 has a lower hardness than the backup region 7, chipping may occur in the edge 61 due to sticking and slipping.

According to this aspect, since the edge region 6 has a higher hardness than the hardness of the non-edge region, escaping residual substances as well as chipping of the edge 61 due to sticking and slipping can be inhibited.

Aspect I

A cleaning device 1 includes the cleaning blade 5 according to Aspect A or B and a spring 81 to press the edge 61 of the cleaning blade 5 against the contact object.

Regarding the method used to press the edge 61 of the cleaning blade 5 to the photoconductor 10 as the contact object, in the pressurized-state attachment in which the cleaning blade 5 being in the pressed state is secured, the line pressure of the edge 61 abutting against the photoconductor 10 significantly decreases when the cleaning blade 5 fatigues. Accordingly, the substances, such as the residual toner are likely to pass between the photoconductor 10 and the edge 61 of the cleaning blade 5, resulting in the defective cleaning.

According to this aspect, in the case of the constant contact-pressure type cleaning device which pressurizes the edge 61 of the cleaning blade 5 toward the photoconductor 10 by using the force of the spring, even if the fatigue of the cleaning blade 5 occurs, the line pressure of the edge 61 abutting against the photoconductor 10 does not decrease significantly and the defective cleaning is inhibited.

Furthermore, by providing the cleaning blade 5 whose edge 61 contacts the contact object according to Aspect A or B, the fatigue of the cleaning blade 5 can be minimized.

Therefore, the cleaning device 1 can be provided, in which decreases in the line pressure are minimized, thereby inhibiting the defective cleaning.

Aspect J

An image forming apparatus 100 includes an image bearer (e.g., the photoconductor 10) to bear an image; a charger (e.g., the charging device 40) to charge a surface of the image bearer, an exposure device (e.g., the exposure device 140) to expose the surface of the charged image bearer to form an electrostatic latent image on the image bearer, a developing device (e.g., the developing device 50) to develop the electrostatic latent image into a toner image (visible image); a transfer device (e.g., the secondary transfer roller 165) to transfer the toner image onto a recording medium; a fixing device (e.g., the fixing device 30) to fix the toner image on the recording medium; and a cleaning device 1 including the cleaning blade 5, whose edge 61 abuts the image bearer, according to Aspect A or B.

In this aspect, the image forming apparatus can clean the image bearer preferably after the image transfer to inhibit the occurrence of the abnormal image with white spots caused by the defective cleaning.

Aspect K

A process cartridge 121 support an image bearer such as the photoconductor 10 and at least cleaning device 1 to remove substances on the image bearer as a single unit. The process cartridge 121 is detachably attachable to a body of an image forming apparatus 100. The cleaning device 1 includes the cleaning blade 5 according to Aspect A or B.

In this aspect, the process cartridge 121 can be provided to clean the image bearer preferably after the image transfer to inhibit the occurrence of the abnormal image with white spots caused by the defective cleaning.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

What is claimed is:

1. A cleaning blade comprising
an elastic blade body,
the elastic blade body having an edge to contact a surface of a contact object that moves in contact with the edge, the cleaning blade to remove substance on the surface of the contact object,
with respect to an elastic power of the contact object, an elastic power of the cleaning blade satisfying a relation:
Y_{OPC}≥0.55×E_{BL}−3.33,
where Y_{OPC} represents the elastic power of the contact object, and E_{BL} represents the elastic power of the cleaning blade.

2. The cleaning blade according to claim 1,
wherein the contact object has a surface roughness of 0.1 μm or more and 0.7 μm or less.

3. The cleaning blade according to claim 1,
wherein the contact object has a surface roughness of 0.3 μm or more and 0.6 μm or less.

4. The cleaning blade according to claim 1,
wherein the contact object has a Martens hardness of 190 N/mm² or more and less than 350 N/mm².

5. The cleaning blade according to claim 1,
wherein the contact object has a Martens hardness of 190 N/mm² or more and less than 310 N/mm².

6. The cleaning blade according to claim 1,
wherein the elastic blade body includes an edge region including the edge and a non-edge-region on a cross-section perpendicular to a direction in which the edge extends, the non-edge-region different in at least one of material and physical property from the edge region, and
wherein an elastic power of the edge region is smaller than an elastic power of the non-edge-region.

7. The cleaning blade according to claim 1,
wherein the elastic blade body includes an edge region including the edge and a non-edge-region on a cross-section perpendicular to a direction in which the edge extends, the non-edge-region different in at least one of material and physical property from the edge region, and
wherein a Martens hardness of the edge region is greater than a Martens hardness of the non-edge-region.

8. A cleaning device comprising:
the cleaning blade according to claim 1; and
a spring to press the edge of the elastic blade body against the contact object.

9. An image forming apparatus comprising:
an image bearer to bear an image;
a charger to charge a surface of the image bearer,
an exposure device to expose the surface of the image bearer charged with the charger, to form an electrostatic latent image on the image bearer;
a developing device to develop the electrostatic latent image into a toner image;
a transfer device to transfer the toner image from the image bearer onto a recording medium;
a fixing device to fix the toner image on the recording medium; and
the cleaning device according to claim 8 to remove toner on the image bearer as the contact object.

10. A process cartridge detachably attachable to a body of an image forming apparatus as a single unit, the process cartridge comprising:
an image bearer to bear a toner image; and
the cleaning device according to claim 8 to remove toner on the image bearer as the contact object.

11. A cleaning blade comprising
an elastic blade body,
the elastic blade body having an edge to contact a surface of a contact object that moves in contact with the edge, the cleaning blade to remove substance on the surface of the contact object,
with respect to an elastic power of the contact object, an elastic power of the cleaning blade satisfying a relation:
Y_{OPC}≥0.61×E_{BL}−3.85,
where Y_{OPC} represents the elastic power of the contact object, and E_{BL} represents the elastic power of the cleaning blade.

12. The cleaning blade according to claim 11,
wherein the contact object has a surface roughness of 0.1 μm or more and 0.7 μm or less.

13. The cleaning blade according to claim 11,
wherein the contact object has a surface roughness of 0.3 μm or more and 0.6 μm or less.

14. The cleaning blade according to claim 11,
wherein the contact object has a Martens hardness of 190 N/mm² or more and less than 350 N/mm².

15. The cleaning blade according to claim 11,
wherein the contact object has a Martens hardness of 190 N/mm² or more and less than 310 N/mm².

16. The cleaning blade according to claim 11,
wherein the elastic blade body includes an edge region including the edge and a non-edge-region on a cross-section perpendicular to a direction in which the edge extends, the non-edge-region different in at least one of material and physical property from the edge region, and
wherein an elastic power of the edge region is smaller than an elastic power of the non-edge-region.

17. The cleaning blade according to claim 11,
wherein the elastic blade body includes an edge region including the edge and a non-edge-region on a cross-section perpendicular to a direction in which the edge extends, the non-edge-region different in at least one of material and physical property from the edge region, and
wherein a Martens hardness of the edge region is greater than a Martens hardness of the non-edge-region.

18. A cleaning device comprising:
the cleaning blade according to claim 11; and
a spring to press the edge of the elastic blade body against the contact object.

19. An image forming apparatus comprising:
an image bearer to bear an image;
a charger to charge a surface of the image bearer,
an exposure device to expose the surface of the image bearer charged with the charger, to form an electrostatic latent image on the image bearer;
a developing device to develop the electrostatic latent image into a toner image;
a transfer device to transfer the toner image from the image bearer onto a recording medium;
a fixing device to fix the toner image on the recording medium; and
the cleaning device according to claim 18 to remove toner on the image bearer as the contact object.

20. A process cartridge detachably attachable to a body of an image forming apparatus as a single unit, the process cartridge comprising:
an image bearer to bear a toner image; and
the cleaning device according to claim 18 to remove toner on the image bearer as the contact object.
